(19) United States
(12) Patent Application Publication
(10) Pub. No.: US 2025/0110294 A1
(43) Pub. Date: Apr. 3, 2025

(54) TECHNOLOGIES FOR AN OPTICAL INTERPOSER WITH ACTUATOR BEAMS

(71) Applicant: Intel Corporation, Santa Clara, CA (US)

(72) Inventors: Chia-Pin Chiu, Tempe, AZ (US); Kaveh Hosseini, Livermore, CA (US)

(73) Assignee: Intel Corporation, Santa Clara, CA (US)

(21) Appl. No.: 18/479,012

(22) Filed: Sep. 30, 2023

(51) Int. Cl. G02B 6/42

(52) U.S. Cl. CPC G02B 6/4226; G02B 6/4243; G02B 6/4268; G02B 6/4274

(57) ABSTRACT

Technologies for an optical interposer with actuator beams are disclosed. In one embodiment, an integrated circuit package includes an optical interposer and a photonics integrated circuit (PIC) die. The optical interposer includes actuator beams and waveguides embedded in the actuator beams. An electrical trace is disposed on the actuator beams. In use, current can pass through the electrical trace, expanding the trace through thermal expansion. The trace expands more than the actuator beam underneath it, causing the actuator beam and the waveguides to be deflected. In this manner, the waveguides in the optical interposer can be positioned to align to waveguides in the PIC die.

### BACKGROUND

Photonic integrated circuits (PICs) can be used for several applications, such as communications. Efficiently and cheaply aligning optics to couple light into and out of PICs can be a challenge. Approaches such as attachment of optical fiber arrays to V-groove arrays in PICs may be slow, incompatible with conventional semiconductor packaging processes, and can result in substantial yield and throughput issues.

### BRIEF DESCRIPTION OF THE DRAWINGS

FIG. 1 is an isometric view of an integrated circuit component with a photonic integrated circuit (PIC) die and an optical interposer.

FIG. 2 is a cross-sectional view of one embodiment of the integrated circuit component of FIG. 1.

FIG. 3 is a bottom-up view of one embodiment of the PIC die and the optical interposer of FIGS. 1 and 2.

FIG. 4 is an isometric view of one embodiment of the optical interposer of FIGS. 1 and 2.

FIG. 5 is an isometric view of part of one embodiment of the optical interposer of FIGS. 1 and 2.

FIG. 6 is a cross-sectional view of one embodiment of the PIC die and the optical interposer of FIGS. 1 and 2.

FIG. 7 is a cross-sectional view of one embodiment of the PIC die and the optical interposer of FIGS. 1 and 2.

FIG. 8 is an isometric view of part of one embodiment of the optical interposer of FIGS. 1 and 2.

FIG. 9 is a cross-sectional view of one embodiment of the PIC die and the optical interposer of FIG. 8.

FIG. 10 is a cross-sectional view of one embodiment of the PIC die and the optical interposer of FIG. 8.

FIG. 11 is a cross-sectional view of one embodiment of the PIC die and the optical interposer of FIG. 8.

FIG. 12 is a cross-sectional view of one embodiment of the PIC die and the optical interposer of FIG. 8.

FIG. 13 is a cross-sectional view of one embodiment of the integrated circuit component of FIG. 1.

FIG. 14 is an isometric view of part of one embodiment of the optical interposer of FIG. 13.

FIG. 15 is a cross-sectional view of one embodiment of the PIC die and the optical interposer of FIG. 13.

FIG. 16 is a cross-sectional view of one embodiment of the PIC die and the optical interposer of FIG. 13.

FIG. 17 is a cross-sectional view of one embodiment of the integrated circuit component of FIG. 1.

FIG. 18 is an isometric view of part of one embodiment of the optical interposer of FIGS. 1 and 2.

FIG. 19 is a cross-sectional view of one embodiment of the PIC die and the optical interposer of FIGS. 1 and 2.

FIG. 20 is a cross-sectional view of one embodiment of the PIC die and the optical interposer of FIGS. 1 and 2.

FIG. 21 is a cross-sectional view of one embodiment of the integrated circuit component of FIG. 1.

FIG. 22 is a cross-sectional view of one embodiment of the integrated circuit component of FIG. 1.

FIG. 23 is a cross-sectional view of one embodiment of the integrated circuit component of FIG. 1.

FIG. 24 is a simplified flow diagram of at least one embodiment of a method for aligning waveguides of the optical interposer of FIG. 1.

FIG. 25 is a top view of a wafer and dies that may be included in a microelectronic assembly, in accordance with any of the embodiments disclosed herein.

FIG. 26 is a cross-sectional side view of an integrated circuit device that may be included in a microelectronic assembly, in accordance with any of the embodiments disclosed herein.

FIGS. 27A-27D are perspective views of example planar, gate-all-around, and stacked gate-all-around transistors.

FIG. 28 is a cross-sectional side view of an integrated circuit device assembly that may include a microelectronic assembly, in accordance with any of the embodiments disclosed herein.

FIG. 29 is a block diagram of an example electrical device that may include a microelectronic assembly, in accordance with any of the embodiments disclosed herein.

### DETAILED DESCRIPTION

In various embodiments disclosed herein, an integrated circuit component includes a photonic integrated circuit (PIC) die and an optical interposer. In use, waveguides defined in the optical interposer are coupled to waveguides in the PIC die for transmitting and receiving data over optical signals. In order to align the waveguides, the optical interposer has actuator beams extending from a body of the optical interposer towards the PIC die, with the waveguides of the optical interposer extending along the actuator beams. The actuator beams can be actuated, moving the waveguides into a position where they are aligned with the waveguides of the PIC die.

The approaches presented below can provide a high-yield, high-throughput optical packing solution, allowing for the provision of high-quality and low-cost alignment between a PIC and an FAU. Applications include data center networking, AI training, and disaggregated systems.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicates via an embedded bridge in a package substrate and an integrated circuit package attached to a printed circuit board that send signals to or receives signals from other integrated circuit packages or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

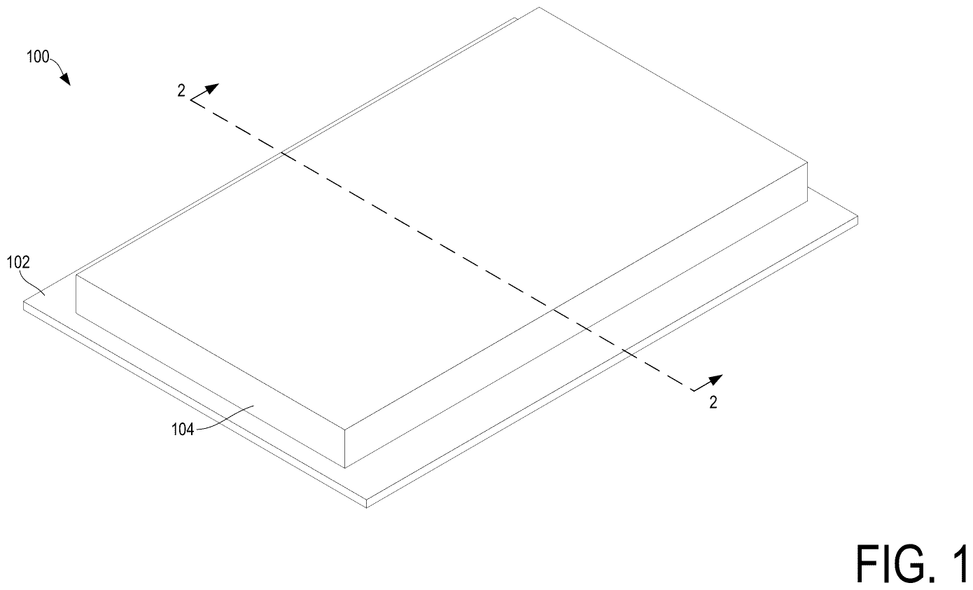

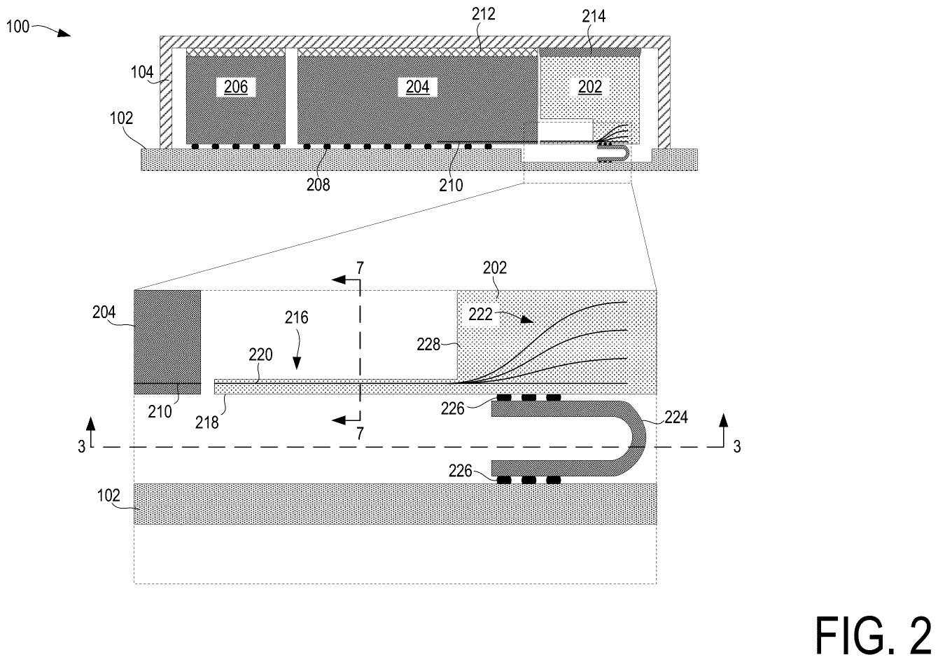

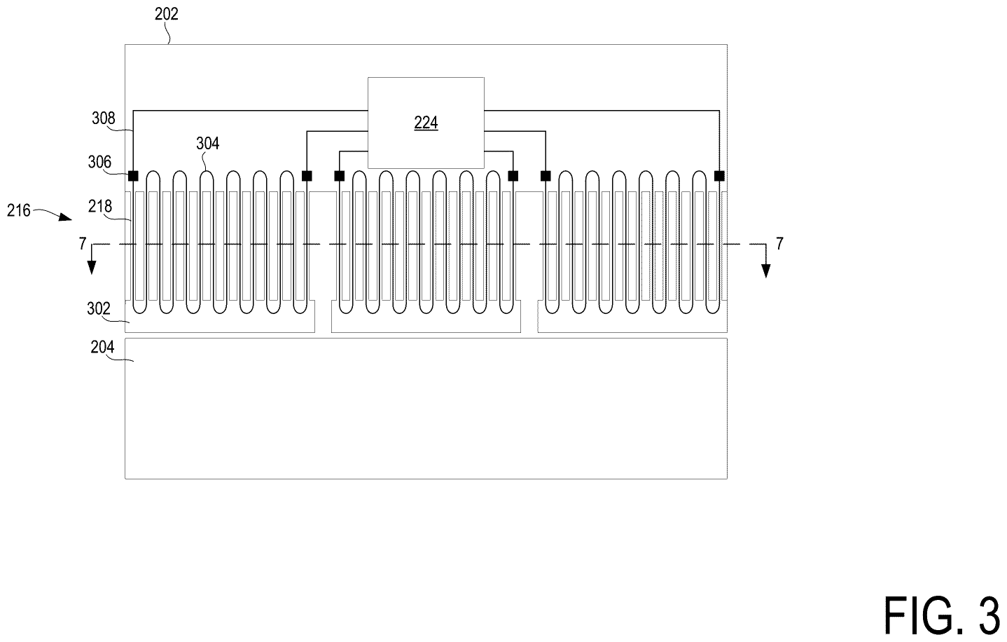

Referring now to FIGS. 1-3, in one embodiment, an integrated circuit component 100 includes a circuit board 102, an integrated heat spreader (IHS) 104, one or more photonic integrated circuit (PIC) dies 204, one or more electronic integrated circuit (EIC) dies 206, and one or more optical interposers 202. FIG. 1 shows a perspective view of the integrated circuit component 100, FIG. 2 shows a cross-sectional view of one embodiment of the integrated circuit component 100 taken at the line marked 2 in FIG. 1, and FIG. 3 shows a bottom up view of one embodiment of the PIC die 204 and the optical interposer 202 taken at the line marked 3 in FIG. 2.

The PIC die has one or more waveguides 210 defined in it. The optical interposer 202 includes one or more arrays 216 of actuator beams 218 extending from a body 228 of the optical interposer 202. In an illustrative embodiment, each actuator beam 218 has a waveguide 220 defined in it. In some embodiments, some of the actuator beams may not include a waveguide 220.

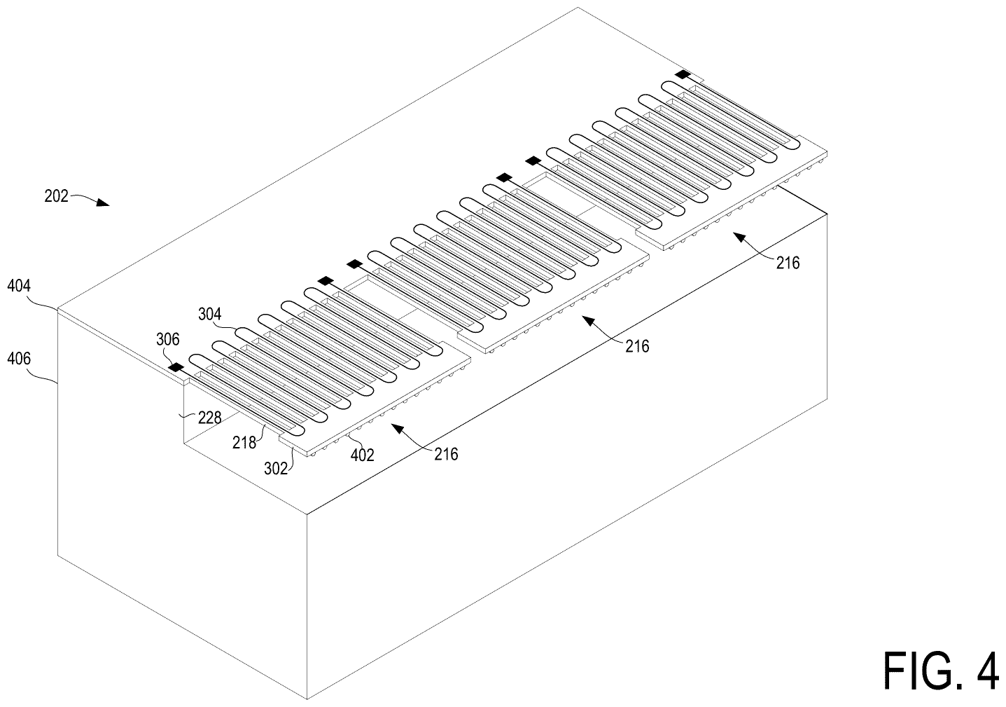

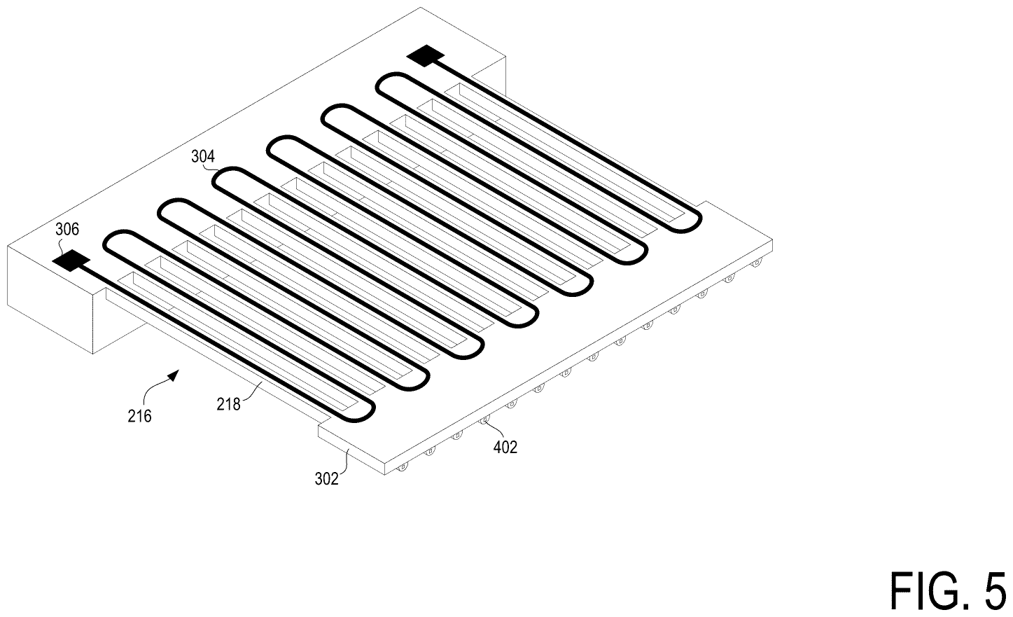

Referring now to FIGS. 4 and 5, in one embodiment, an isometric view of the optical interposer 202 is shown in FIG. 4, and a zoomed-in view on one array 216 of actuator beams 218 is shown in FIG. 5. The optical interposer 202 may have several arrays 216 of actuator beams 218 that can move independently, as shown in FIG. 4. In an illustrative embodiment, the actuator beams 218 of each array 216 are connected at an end by a crossbar 302. An end 402 of each waveguide 220 is at the end of each actuator beam 218. Each array 216 of actuator beams 218 includes one or more traces 304 extending along a top surface of some or all of the actuator beams 218. The traces 304 may be connected to pads 306, which in turn are connected by traces 308 to a cable 224.

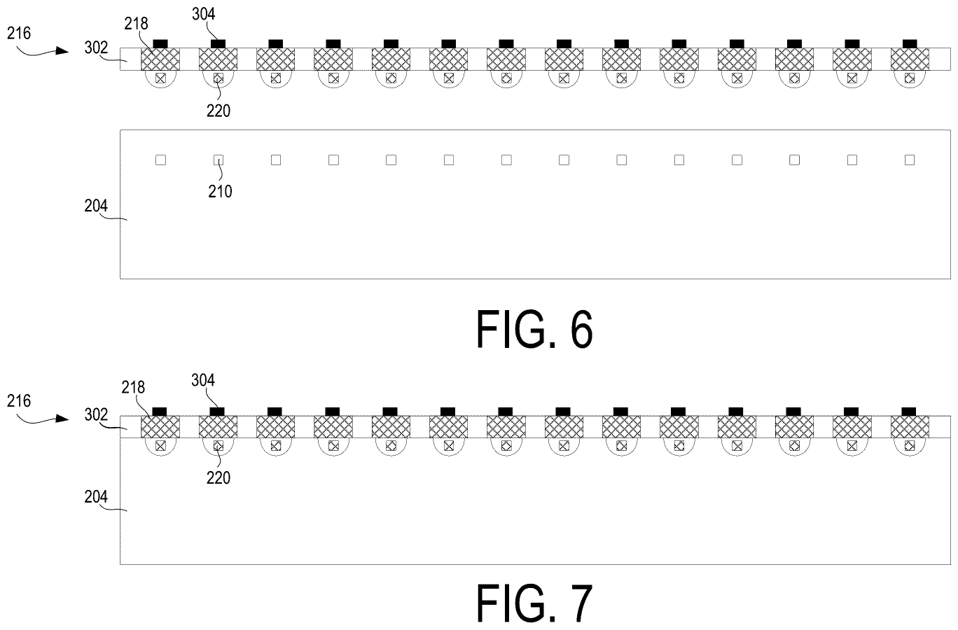

Referring now to FIGS. 6 and 7, in use, FIGS. 6 and 7 show cross-sectional views taken perpendicular to the beam array 216 looking towards the PIC die 204. In one embodiment, the waveguides 220 in the optical interposer 202 may not be aligned to the waveguides 210 in the PIC die 204, as shown in FIG. 6. For example, the substrate 102, the PIC die 204, and/or the optical interposer 202 may warp or otherwise shift during packaging, solder reflow, etc. In order to align the waveguides 220 in the optical interposer 202 to the waveguides 210 in the PIC die 204, the actuators beams 218 can be actuated to move the ends 402 of the waveguides 220 down. In an illustrative embodiment, the actuator beams 218 are actuated by passing current through the trace 304. The trace 304 heats up and expands. In particular, the trace 304 expands more than the underlying actuator beam 218 due to a higher coefficient of thermal expansion (CTE) and/or due to being at a higher temperature. The expansion of the trace 304 pushes the actuator array 216 down from the perspective of FIGS. 6 and 7, aligning the waveguides 220 to the waveguides 210.

Referring back to FIGS. 1-3, the illustrative circuit board 102 may be made from ceramic, glass, and/or organic-based materials with fiberglass and resin, such as FR-4. The circuit board 102 may have any suitable length or width, such as 10-500 millimeters. The circuit board 102 may have any suitable thickness, such as 0.2-5 millimeters. The circuit board 102 may support additional components besides the components shown in FIGS. 1-3, such as additional photonic or electronic integrated circuit components, a memory device, additional circuit components, etc.

The one or more PIC dies 204 may be made of any suitable material, such as silicon. In an illustrative embodiment, the PIC dies 204 include a silicon oxide cladding layer in which silicon waveguides 210 are embedded. In some embodiments, the waveguides 210 may be embodied as, e.g., Si₃N₄ or SiON. The PIC die 204 may include any suitable number of waveguides 210 or channels, such as 1-1,024. The optical interposer 202 may include a waveguide 220 for each waveguide 210 of the PIC die 204. The light carried in the waveguides 210, 220 may have any suitable wavelength, such as 1,270-1,340 nanometers, 1,500-1,600 nanometers, etc.

The PIC die 204 is configured to generate, detect, and/or manipulate light. The PIC die 204 may include active or passive optical elements such as splitters, couplers, filters, optical amplifiers, lasers, photodetectors, modulators, etc. The PIC die 204 may have electrical connections to the substrate 102 and/or to EIC die 206, such as for power delivery, sending and receiving data, and/or the like. In some embodiment, the PIC die 204 may be mounted on an EIC die 206, or an EIC die 206 may be mounted on the PIC die 204.

The one or more EIC dies 206 may include any suitable analog and/or digital circuitry, such as a processor, a memory, an application-specific integrated circuit (ASIC), a field-programmable gate array (FPGA), etc. The EIC dies 206 may be embodied as, form part of, or include a central processing unit (CPU), a graphics processing unit (GPU), or any other processing using (XPU). The one or more EIC dies 206 may include any suitable electronic integrated circuit component, such as resistors, capacitors, inductors, transistors, etc. In some embodiments, the integrated circuit component 100 may be embodied as a router, a switch, a network interface controller, and/or the like. In such embodiments, the EIC dies 206 may include network interface controller circuitry to process, parse, route, etc., network packets sent and received by the integrated circuit component 100 through the optical interposer 202. The EIC dies 206 may have any suitable length or width, such as 1-300 millimeters. The EIC dies 302 may have any suitable thickness, such as 0.05-5 millimeters.

In an illustrative embodiment, the EIC dies 206 and the PIC dies 204 are connected to the circuit board 102 with solder balls 208. A thermal interface material (TIM) 212 is between the dies 204, 206 and the IHS 104. The TIM 212 may be any suitable material, such as a silver thermal compound.

The IHS 104 may be made out of or otherwise include any suitable material, such as copper, aluminum, tin, or other material with a high thermal conductivity. In use, a heat sink or cold plate may be mated with the IHS 104 to remove heat.

The optical interposer 202 is configured to interface with an optical connector, such as an array of optical fibers (not shown in the figures). The optical connector may be embodied as, e.g., an MT connector. The optical connector may include, e.g., 1-1,024 optical fibers. The waveguides 220 in the optical interposer 202 may be routed in three dimensions to an expanded array 222 that can interface with the optical connector. The optical interposer 202 may have any suitable dimensions, such as a length and width of 5-50 millimeters and a thickness of 1-20 millimeters.

The waveguides 220 in the optical interposer 202 may be any suitable waveguide in any suitable cladding. For example, the waveguides 220 may be silicon, Si₃N₄, or SiON waveguides in a silicon substrate. In another example, the waveguides 220 may be embodied as direct-write waveguides formed using direct laser writing, in which a laser is used to locally change the index of refraction of the optical interposer 202 to directly write waveguides 220 in the optical interposer 202. In one embodiment, The optical interposer 202 includes a silicon oxide waveguide layer 404 formed on top of a silicon substrate layer 406.

The optical interposer 202 may be made of any suitable material, such as silicon oxide or silicon. In various embodiments, the optical interposer 202 may be made of any suitable material that may be crystalline, non-crystalline, amorphous, etc., such as fused silicon, borosilicate, sapphire, yttrium aluminum garnet, etc. The optical interposer 202 may be, e.g., aluminosilicate glass, borosilicate glass, alumino-borosilicate glass, silica, fused silica, etc. The optical interposer 202 may include one or more additives, such as Al2O3, B2O3, MgO, CaO, SrO, BaO, SnO2, Na2O, K2O, SrO, P2O3, ZrO2, Li2O, Ti, and Zn. The optical interposer 202 may comprise silicon and oxygen, as well as any one or more of aluminum, boron, magnesium, calcium, barium, tin, sodium, potassium, strontium, phosphorus, zirconium, lithium, titanium, and zinc. The optical interposer 202 may include at least 20-40 percent silicon by weight, at least 20-40 percent oxygen by weight, and at least 5 percent aluminum by weight. For example, some embodiments of the optical interposer 202 may include, e.g., at least 20-23 percent silicon and at least 20-26 percent oxygen by weight.

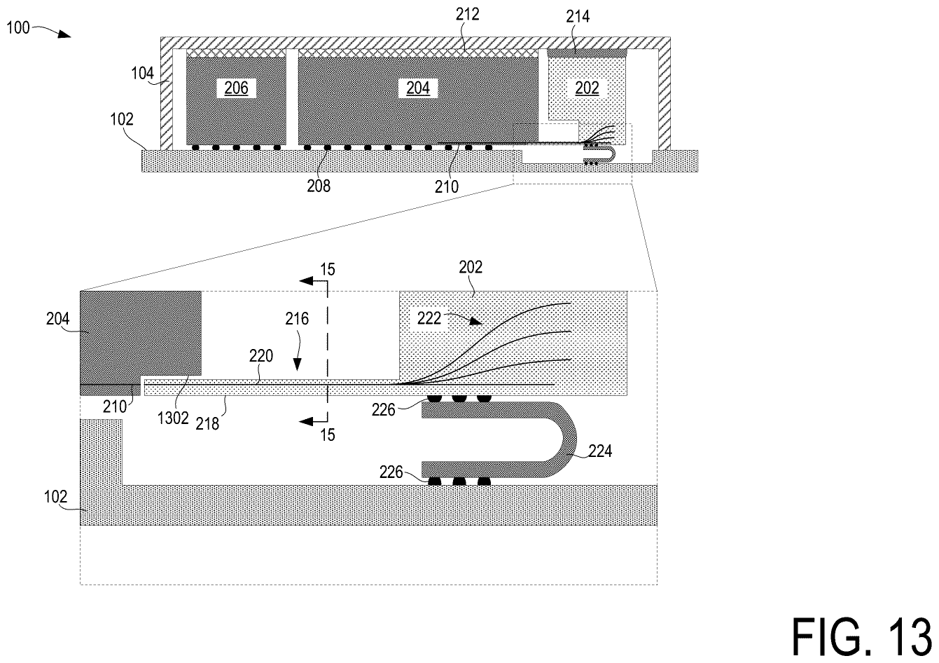

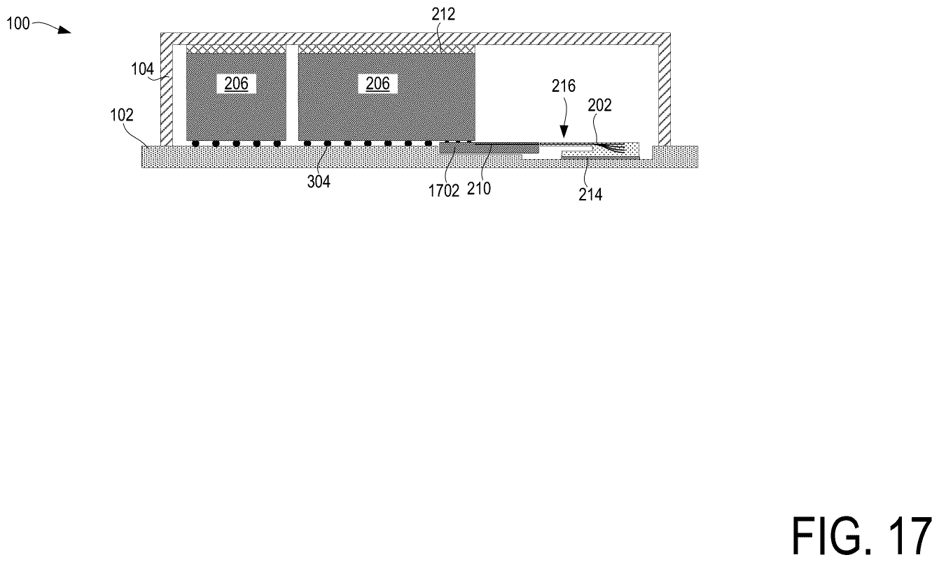

In an illustrative embodiment, the optical interposer 202 is secured to the IHS 104 by epoxy 214 or other adhesive. The illustrative PIC die 204 has end-coupled waveguides 210 without a V-groove, and the waveguides 220 are aligned directly to the waveguides 210. In other embodiments, the optical interposer 202 may be mounted or interface with the PIC die 204 in a different manner, as described below in regard to FIGS. 13 and 17.

The optical interposer 202 may include any suitable number of actuator beam arrays 216, such as 1-64. Each actuator array 216 may include any suitable number of actuator beams 218, such as 2-64. Each actuator beam 218 may have any suitable dimensions, such as a width or height of, e.g., 5-50 micrometers and a length of, e.g., 100-2,000 micrometers. The actuator beam array 216 may have any suitable pitch, such as 10-100 micrometers. The actuator beams 218 may be made of a similar material as the optical interposer 202, a description of which will not be repeated in the interest of clarity. In an illustrative embodiment, the waveguides 220 are disposed in a protrusion that extends from a bottom surface of each actuator beam 218, as can be seen in, e.g., FIGS. 5-7. In other embodiments, the waveguides 220 may be disposed in the core of each actuator beam 218.

In an illustrative embodiment, the traces 304 are made of polysilicon. The traces 304 may have any suitable width and thickness, such as 1-20 micrometers. In other embodiments, the traces 304 may be made of any suitable material, such as copper, aluminum, or other conductor. In an illustrative embodiment, the actuator beams 218 actuate due to expansion of the traces 304 when current passes through them. Any suitable amount of current may pass through the traces 304, such as 0-10 milliamps. Additionally or alternatively, in other embodiments, the actuator beams 218 may actuate based on, e.g., electrostatic attraction, electromagnetic force, electrostriction, piezoelectric effect, etc. The actuator beams 218 may be made of materials that can directly actuate, or the actuator beams 218 may have an auxiliary component (such as the trace 304) that causes them to actuate. The actuator beams 218 may deflect any suitable maximum amount, such as 10-50 micrometers. It should be appreciated that the actuator beams 218 can be positioned in any position from zero deflection up to the maximum deflection, simply by varying the amount of current in the traces 304.

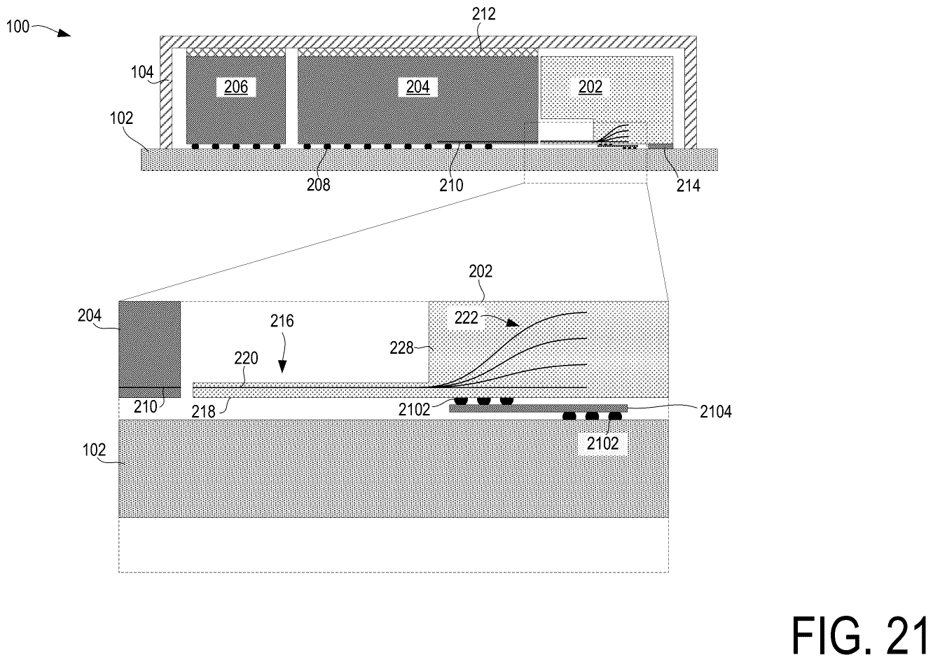

In an illustrative embodiment, the traces 304 that control the actuator beams 218 are connected to a ribbon cable 224 through solder balls 226. The ribbon cable 224 may connect to another component, such as the substrate 102 through solder balls 226. In some embodiments, the ribbon cable 224 may connect to the PIC die 204, the EIC die 206, another EIC die 206, etc. The ribbon cable 224 may be communicatively coupled to control circuitry, e.g., through the substrate 102 to another component such as an EIC die 206 or another integrated circuit component. The control circuitry can control the actuator beams 218 to align the waveguides 210, 220, as described below in more detail in regard to FIG. 21. In another embodiment, the traces 304 may connect to a component other than a ribbon cable 224, such as directly to the substrate 102, directly to an EIC die 206, directly to the PIC die 204, etc.

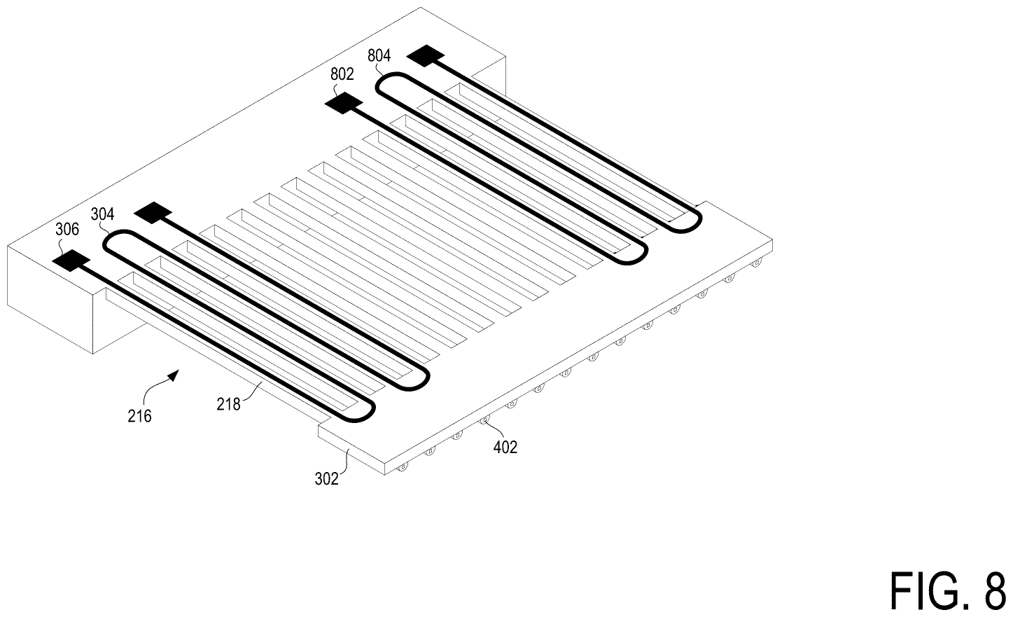

Referring now to FIG. 8, in one embodiment, an actuator array 216 may have trace 304 disposed on the actuator beams 218 at one end of the array 216 and may have trace 804 disposed on actuator beams 218 at the other end of the array 216. The trace 804 may be connected to pads 802, which may be connected to the ribbon cable 224 (not shown in FIG. 8). In use, the trace 804 can be heated up separately from the trace 304. As such, the end of the array 216 under the trace 304 can be actuated independently of the end of the array 216 under the trace 804, allowing the array 216 to twist as well as deflect downward. Passing current through the trace 304 twists the array 216 in one direction, and passing current through the trace 804 twists the array 216 in the opposite direction.

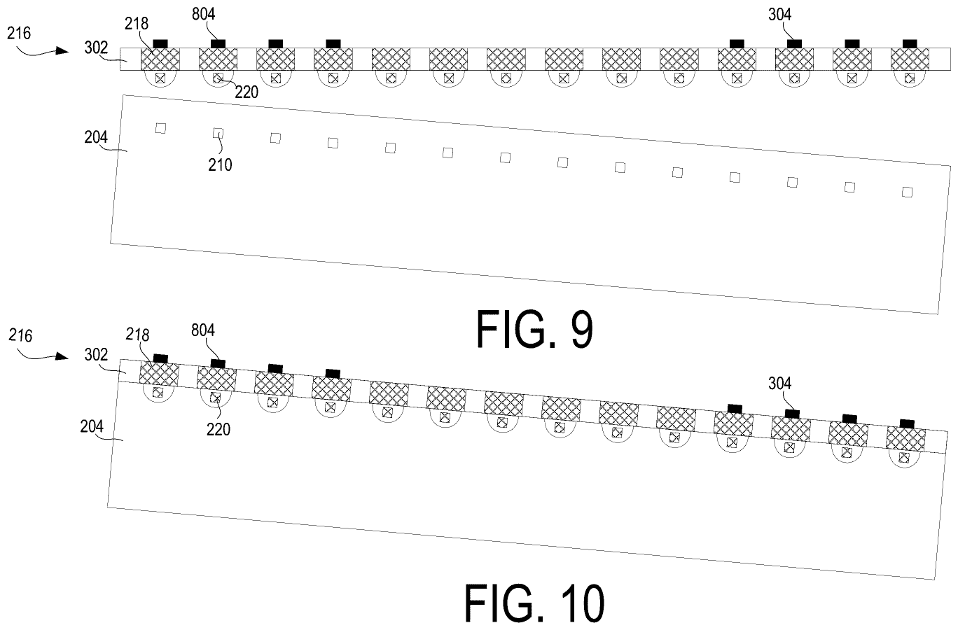

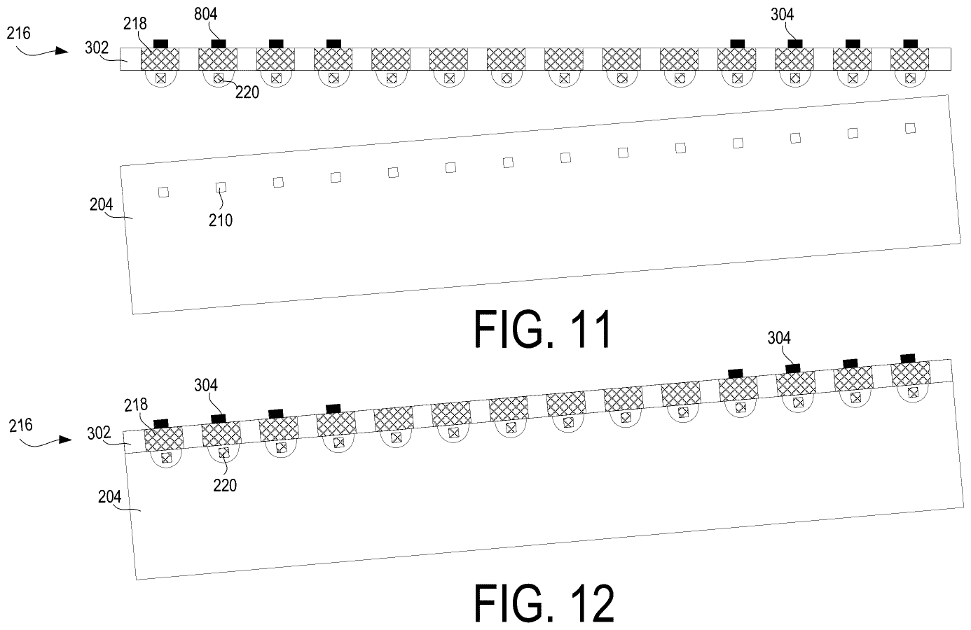

For example, referring now to FIGS. 9-12, cross-sectional views show the actuator beam array 216 and the PIC die 204. In one embodiment, the right side of the PIC die 204, from the perspective of FIG. 9, is deflected downward more than the left side of the PIC die 204, as shown in FIG. 9. More current can be passed through trace 304 than trace 804, deflecting the right end of the array 216 from the perspective of FIG. 9 more than the left end, aligning the array 216 to the PIC die 204, as shown in FIG. 10. In another embodiment, the left side of the PIC die 204 from the perspective of FIG. 11 is deflected downward more than the right side of the PIC die 204, as shown in FIG. 11. More current can be passed through trace 804 than trace 304, deflecting the left end of the array 216 from the perspective of FIG. 11 more than the right end, aligning the array 216 to the PIC die 204, as shown in FIG. 12.

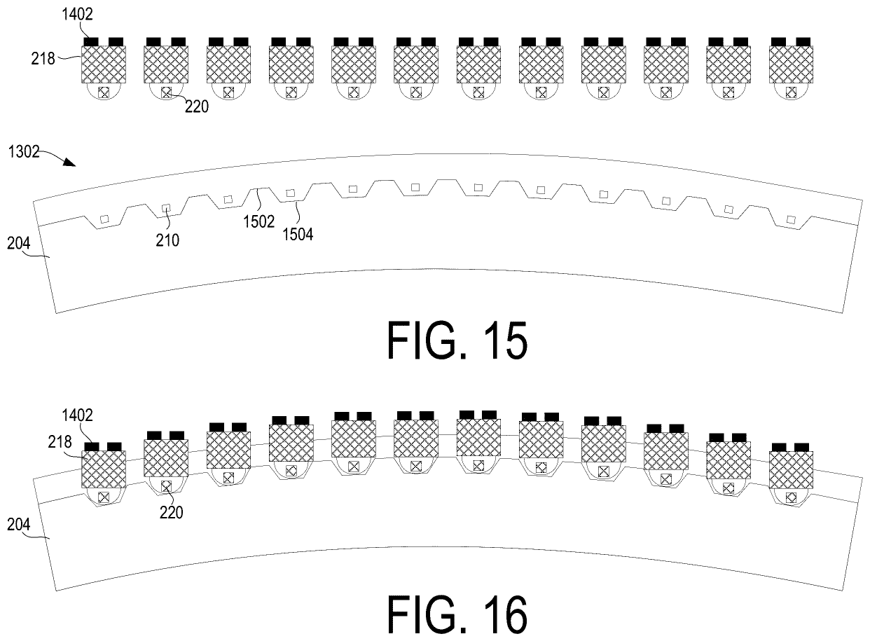

Referring now to FIG. 13, in one embodiment, the PIC die 204 may have a V-groove array 1302 defined in it. The actuator beams 218 may align with the V-groove array 1302. The V-groove array 1302 includes a series of alternating peaks 1502 and valleys 1504 that define the V-grooves, as shown in FIG. 15. In an illustrative embodiment, the V-groove array 1302 has a pitch of about 160 micrometers and a depth (i.e., vertical distance between the peaks 1502/valleys 1504) of about 110 microns. In other embodiments, the V-groove array 1302 may have any suitable pitch or depth, such as 30-500 micrometers. The V-groove array 1302 in the PIC die 204 may be made in any suitable manner, such as by being etched from the substrate of the PIC die 204, such as by using 2D and 3D lithography. In some embodiments, the V-groove array 1302 may be formed from another material, such as a material grown on or adhered to the PIC die 204.

In use, the actuator array 216 can be deflected down towards the V-groove array 1302. In some embodiments, the V-groove array 1302 may prevent the actuator array 216 from overshooting the waveguides 210, increasing the ease of alignment.

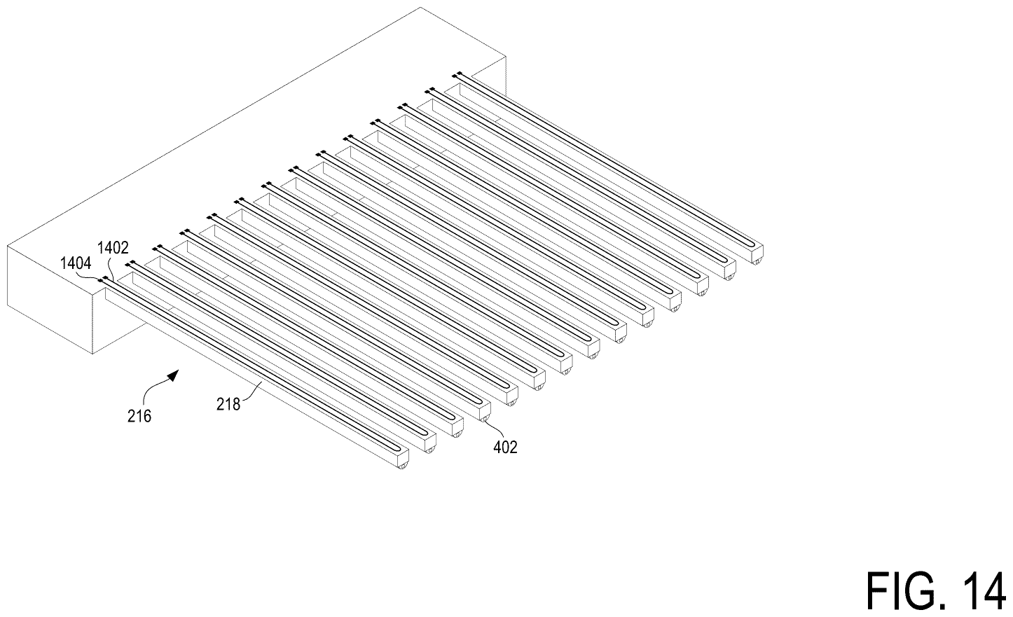

Referring now to FIG. 14, in one embodiment, an actuator array 216 may include independent actuator beams 218 that are not connected by a crossbar 302. Each actuator beam 218 has a trace 1402 routed on it connected to pads 1404. The pads 1404 may be connected to, e.g., the ribbon cable 224. The amount of current through each trace 1402 can be controlled individually, allowing for the deflection of each actuator beam 218 to be controlled individually.

For example, referring now to FIG. 15, a PIC die 204 may have a warpage that leads to a variable deflection. An actuator array 216 with a crossbar 302 may not be able to be aligned to all of the waveguides 210. However, the actuator array 216 without the crossbar 302 can have the actuator beams 218 deflected a different amount for each actuator beam 218, allowing each waveguide 220 in the PIC die 204 to be aligned to each waveguide 210 in the optical interposer 202, as shown in FIG. 16.

Referring now to FIG. 17, in one embodiment, an open cavity PIC die 1702 is disposed in a recess of the substate 102, as shown in FIG. 17. The PIC die 1702 may be mounted on an underside of an EIC die 206. The optical interposer 202 may interface with the PIC die 1702 in a similar manner as the PIC dies 204 described above, a description of which will not be repeated in the interest of clarity.

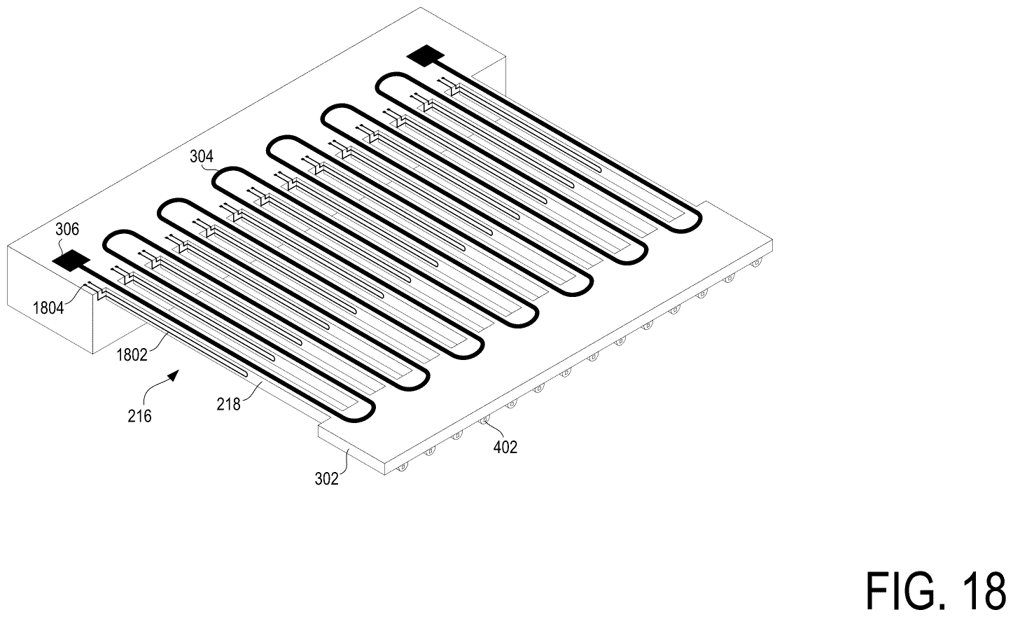

Referring now to FIG. 18, in one embodiment, an actuator array 216 may include traces 1802 disposed on the side surface of each actuator beam 218. The traces 1802 may be connected to pads 1804, which may be connected to the ribbon cable 224. The traces 1802 can deflect the actuator beams 218 laterally, in an orthogonal direction to the deflection due to the traces 304. In this way, the position of the ends 402 of the waveguides 220 in the actuator beams 218 can be controlled in two dimensions.

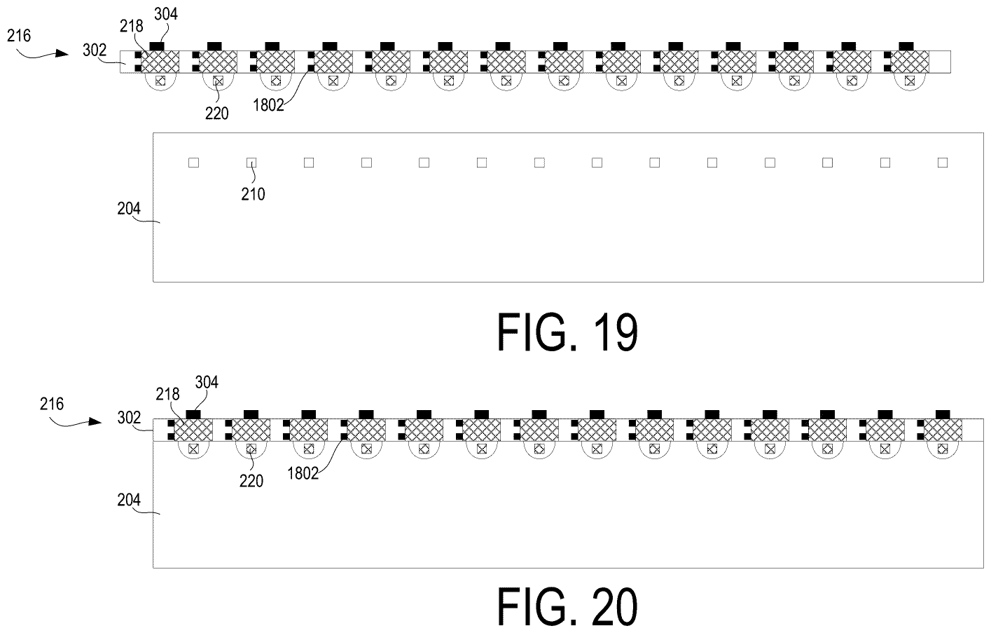

For example, referring now to FIG. 19, a PIC die 204 may have waveguides 210 offset vertically and laterally relative to the waveguides 220. The actuator array 216 can deflect both downward and laterally, aligning the waveguides 220 to the waveguides 210, as shown in FIG. 20.

It should be appreciated that the various embodiments disclosed herein are not the exclusive embodiments. For example, various embodiments described above may be combined, such as having actuator beam 218 without a crossbar 302 and with individual traces 1402 on top and individual traces 1802 on the side, allowing each actuator beam 218 to be moved in two dimensions independently. Additionally, any suitable embodiment of the optical interposer 202 may be placed in any suitable position in the package and combined with any suitable PIC die 204, 1702, such as shown in FIGS. 2, 13, and 17. In addition to or as an alternative to the traces 304 on top of the actuator beams 218, in some embodiments, traces may be placed on the bottom of the actuator beams 218, allowing them to be deflected in the opposite direction. In addition to or as an alternative to the actuator beams 218 being on the optical interposer 202, in some embodiments, the actuator beams 218 may be on the PIC die 204, and the PIC die 204 can move the waveguides 210 in the actuator beams 218 to align to the waveguides 220 in the optical interposer 202. For example, FIG. 4 may be a figure showing such an embodiment of the PIC die 204.

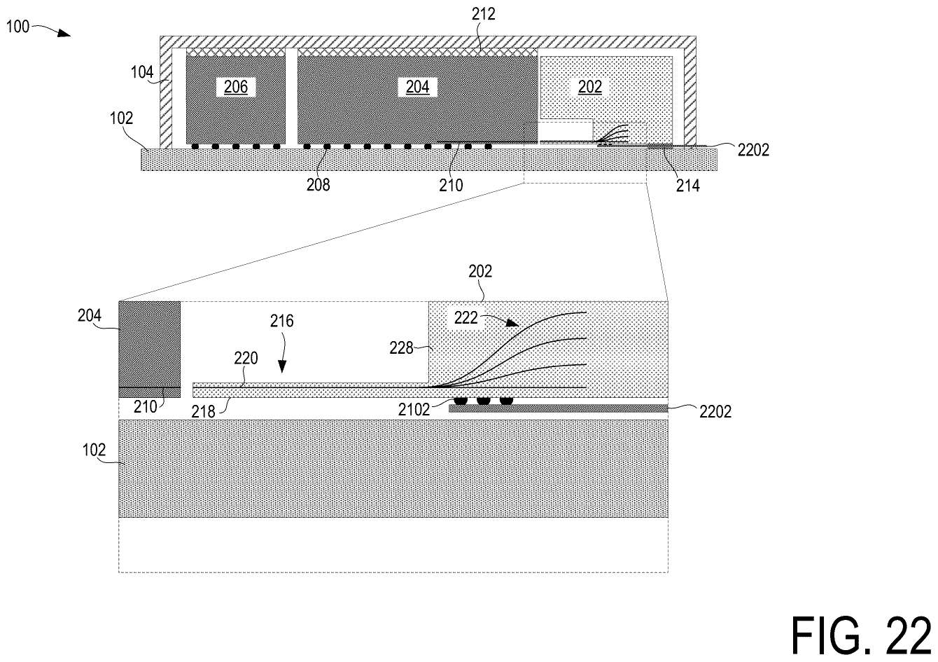

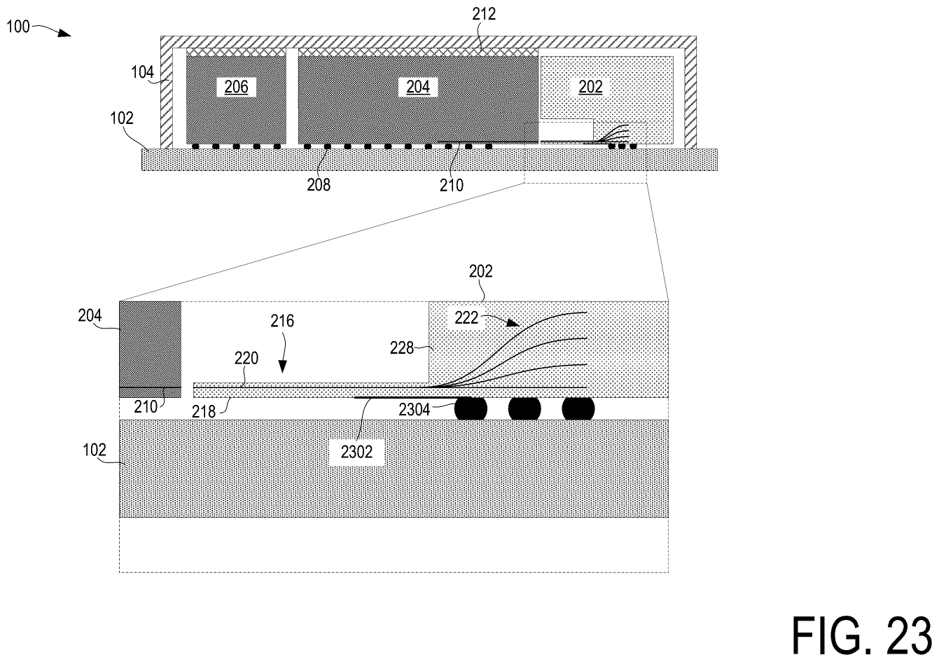

In one embodiment, as shown in FIG. 21, the optical interposer 202 may be secured to the substrate 102 by epoxy 214 or other adhesive. The traces 304, 308, etc., may be connected by solder 2102 to a ribbon cable 2104. The ribbon cable 2104 may be connected to the substrate 102 by solder 2102. The cables in the ribbon cable 2104 may be used to control the actuator beam array 216. In another embodiment, the ribbon cable 2202 may extend past the IHS 104, as shown in FIG. 22. In some embodiments, the connections in the ribbon cable 2202 may be grouped with optical fibers connected to the optical interposer 202, such as by a fiber attach unit. The combined optical and electrical cable may then be connected to another component. In another embodiment, the optical interposer 202 may be secured to the substrate 102 by solder 2304, as shown in FIG. 23. Traces 2302 may connect the traces 304, 308, etc., that are used to control the actuator beams 218 to the solder 2304. From there, the traces 304, 308, etc., may be connected to, e.g., the PIC die 204, the EIC die 206, another component, etc.

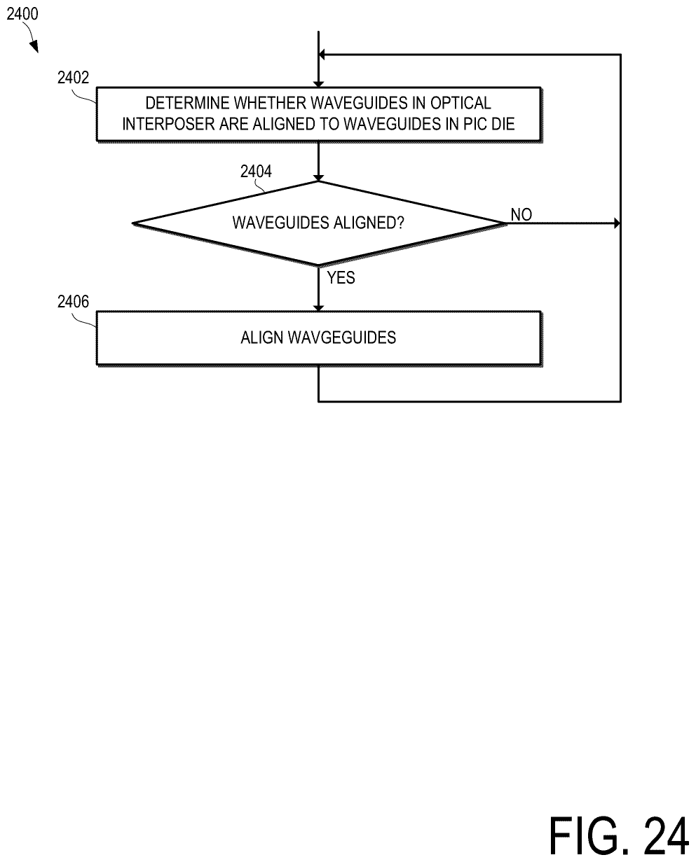

Referring now to FIG. 24, in one embodiment, a flowchart for a method 2400 for aligning waveguides 220 in an optical interposer 202 with waveguides 210 in a PIC die 204. The method 2400 may be executed by control circuitry, such as software, hardware, or firmware. In some embodiments, the control circuitry may be embodied in an EIC die, such as the EIC die 204. The control circuitry may be embodied as a processor, memory, a program stored in memory and executed by the processor, dedicated hardware circuitry for controlling the actuator beams 218, a proportional-integral-differential (PID) controller, and/or the like. The method 2400 may be performed at any suitable time and in any suitable environment. For example, in one embodiment, the method 2400 may be performed to test the function of the optical interposer 202 and/or the PIC die 204, such as at a time of manufacture. In some embodiments, the method 2400 may be performed to align the waveguides 210, 220, and then the actuator beams 218 may be fixed in place using, e.g., epoxy. In some embodiments, the method 2400 may be performed, and values for current in the traces 304 may be stored to be used to align the actuator beams 218 at a later time. In another example, the method 2400 may be performed continuously or continually while the integrated circuit component 100 is powered on. In another example, the method 2400 may be performed after a change of environment, such as a temperature change, a vibration, or a mechanical shock.

The method 2400 begins in block 2402, in which control circuitry determines whether the waveguides 220 in the optical interposer 202 are aligned to waveguides 210 in a PIC die 204. The control circuitry may, e.g., determine an amount of transmission loss when coupling between the waveguides 210, 220, such as by using an active signal or a test signal. The control circuitry may slightly vary the current in the traces 304 to determine whether the waveguides 210, 220 are aligned.

In block 2404, if the waveguides 210, 220 are aligned, the method 2400 loops back to block 2402, to again check whether the waveguides 210, 220 are aligned. If the waveguides 210, 220 are not aligned, the method 2400 proceeds to block 2406.

In block 2406, the control circuitry aligns the waveguides 210, 220. The control circuitry may use an optical signal as feedback to align the waveguides 210, 220. In some embodiments, the waveguides 210, 220 may not have enough coupling for an optical signal to be used as feedback. In such an embodiment, the control circuitry may perform, e.g., a one- or two-dimensional search to find an optical signal to optimize on. After aligning, the method 2400 loops back to block 2402.

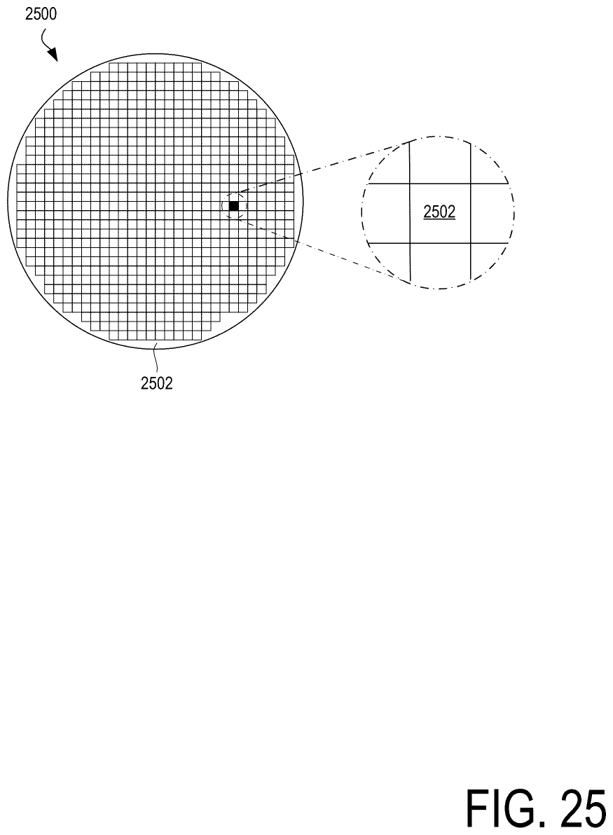

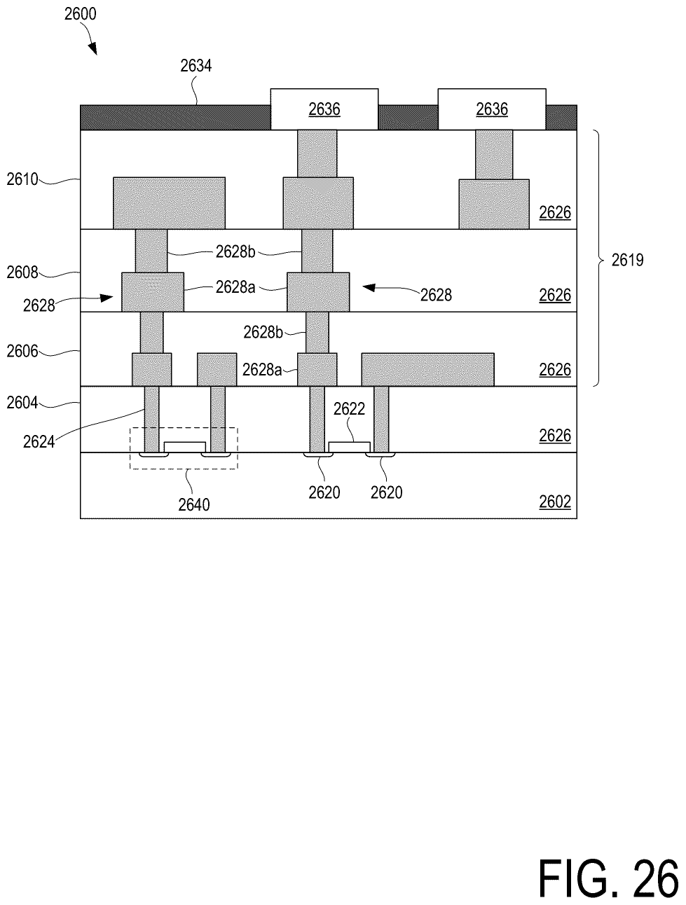

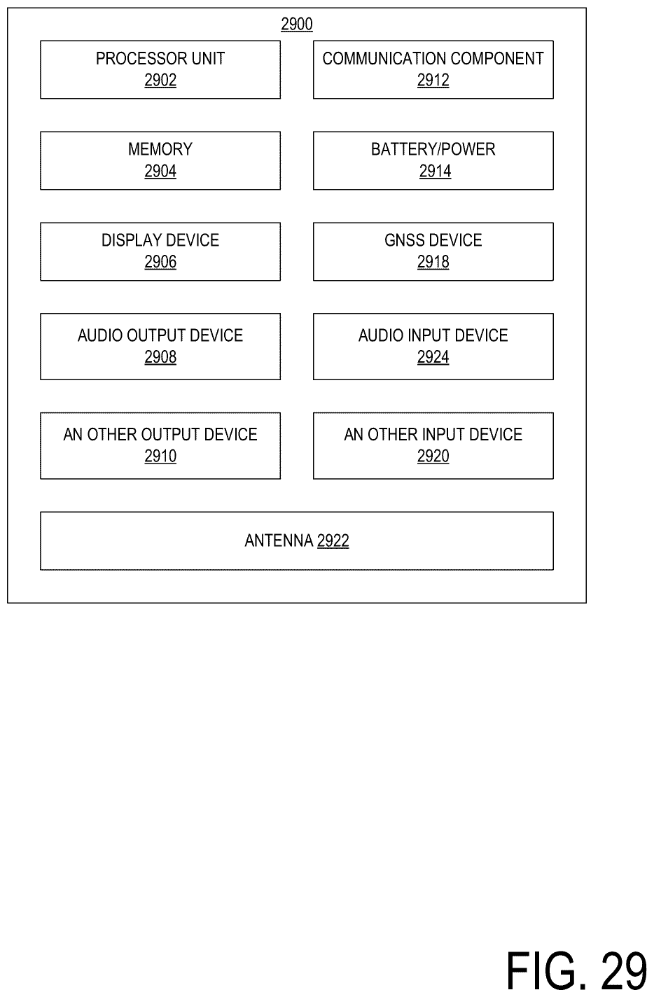

FIG. 25 is a top view of a wafer 2500 and dies 2502 that may be included in any of the integrated circuit components 100 disclosed herein (e.g., as any suitable ones of the dies 204, 206). The wafer 2500 may be composed of semiconductor material and may include one or more dies 2502 having integrated circuit structures formed on a surface of the wafer 2500. The individual dies 2502 may be a repeating unit of an integrated circuit product that includes any suitable integrated circuit. After the fabrication of the semiconductor product is complete, the wafer 2500 may undergo a singulation process in which the dies 2502 are separated from one another to provide discrete “chips” of the integrated circuit product. The die 2502 may be any of the dies 204, 206 disclosed herein. The die 2502 may include one or more transistors (e.g., some of the transistors 2640 of FIG. 26, discussed below), supporting circuitry to route electrical signals to the transistors, passive components (e.g., signal traces, resistors, capacitors, or inductors), and/or any other integrated circuit components. In some embodiments, the wafer 2500 or the die 2502 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 2502. For example, a memory array formed by multiple memory devices may be formed on a same die 2502 as a processor unit (e.g., the processor unit 2902 of FIG. 29) or other logic that is configured to store information in the memory devices or execute instructions stored in the memory array. Various ones of the integrated circuit components 100 disclosed herein may be manufactured using a die-to-wafer assembly technique in which some dies 204, 206 are attached to a wafer 2500 that include others of the dies 204, 206, and the wafer 2500 is subsequently singulated.

FIG. 26 is a cross-sectional side view of an integrated circuit device 2600 that may be included in any of the integrated circuit components 100 disclosed herein (e.g., in any of the dies 204, 206). One or more of the integrated circuit devices 2600 may be included in one or more dies 2502 (FIG. 25). The integrated circuit device 2600 may be formed on a die substrate 2602 (e.g., the wafer 2500 of FIG. 25) and may be included in a die (e.g., the die 2502 of FIG. 25). The die substrate 2602 may be a semiconductor substrate composed of semiconductor material systems including, for example, n-type or p-type materials systems (or a combination of both). The die substrate 2602 may include, for example, a crystalline substrate formed using a bulk silicon or a silicon-on-insulator (SOI) substructure. In some embodiments, the die substrate 2602 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 2602. Although a few examples of materials from which the die substrate 2602 may be formed are described here, any material that may serve as a foundation for an integrated circuit device 2600 may be used. The die substrate 2602 may be part of a singulated die (e.g., the dies 2502 of FIG. 25) or a wafer (e.g., the wafer 2500 of FIG. 25).

The integrated circuit device 2600 may include one or more device layers 2604 disposed on the die substrate 2602. The device layer 2604 may include features of one or more transistors 2640 (e.g., metal oxide semiconductor field-effect transistors (MOSFETs)) formed on the die substrate 2602. The transistors 2640 may include, for example, one or more source and/or drain (S/D) regions 2620, a gate 2622 to control current flow between the S/D regions 2620, and one or more S/D contacts 2624 to route electrical signals to/from the S/D regions 2620. The transistors 2640 may include additional features not depicted for the sake of clarity, such as device isolation regions, gate contacts, and the like. The transistors 2640 are not limited to the type and configuration depicted in FIG. 26 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

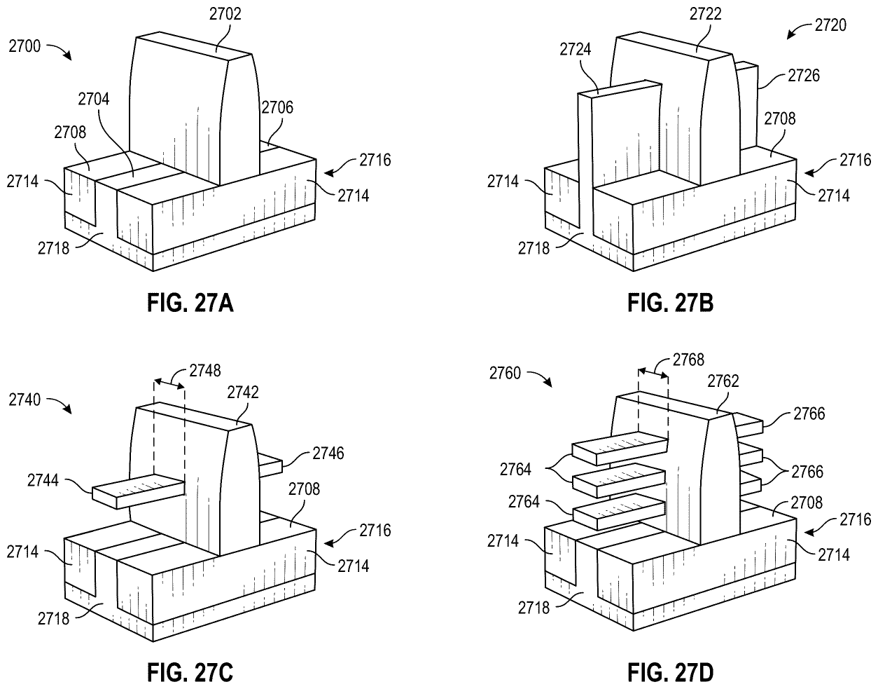

FIGS. 27A-27D are simplified perspective views of example planar, FinFET, gate-all-around, and stacked gate-all-around transistors. The transistors illustrated in FIGS. 27A-27D are formed on a substrate 2716 having a surface 2708. Isolation regions 2714 separate the source and drain regions of the transistors from other transistors and from a bulk region 2718 of the substrate 2716.

FIG. 27A is a perspective view of an example planar transistor 2700 comprising a gate 2702 that controls current flow between a source region 2704 and a drain region 2706. The transistor 2700 is planar in that the source region 2704 and the drain region 2706 are planar with respect to the substrate surface 2708.

FIG. 27B is a perspective view of an example FinFET transistor 2720 comprising a gate 2722 that controls current flow between a source region 2724 and a drain region 2726. The transistor 2720 is non-planar in that the source region 2724 and the drain region 2726 comprise “fins” that extend upwards from the substrate surface 2728. As the gate 2722 encompasses three sides of the semiconductor fin that extends from the source region 2724 to the drain region 2726, the transistor 2720 can be considered a tri-gate transistor. FIG. 27B illustrates one S/D fin extending through the gate 2722, but multiple S/D fins can extend through the gate of a FinFET transistor.

FIG. 27C is a perspective view of a gate-all-around (GAA) transistor 2740 comprising a gate 2742 that controls current flow between a source region 2744 and a drain region 2746. The transistor 2740 is non-planar in that the source region 2744 and the drain region 2746 are elevated from the substrate surface 2728.

FIG. 27D is a perspective view of a GAA transistor 2760 comprising a gate 2762 that controls current flow between multiple elevated source regions 2764 and multiple elevated drain regions 2766. The transistor 2760 is a stacked GAA transistor as the gate controls the flow of current between multiple elevated S/D regions stacked on top of each other. The transistors 2740 and 2760 are considered gate-all-around transistors as the gates encompass all sides of the semiconductor portions that extends from the source regions to the drain regions. The transistors 2740 and 2760 can alternatively be referred to as nanowire, nanosheet, or nanoribbon transistors depending on the width (e.g., widths 2748 and 2768 of transistors 2740 and 2760, respectively) of the semiconductor portions extending through the gate.

Returning to FIG. 26, a transistor 2640 may include a gate 2622 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 2640 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 2640 along the source-channel-drain direction, the gate electrode may consist of a U-shaped structure that includes a bottom portion substantially parallel to the surface of the die substrate 2602 and two sidewall portions that are substantially perpendicular to the top surface of the die substrate 2602. In other embodiments, at least one of the metal layers that form the gate electrode may simply be a planar layer that is substantially parallel to the top surface of the die substrate 2602 and does not include sidewall portions substantially perpendicular to the top surface of the die substrate 2602. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 2620 may be formed within the die substrate 2602 adjacent to the gate 2622 of individual transistors 2640. The S/D regions 2620 may be formed using an implantation/diffusion process or an etching/deposition process, for example. In the former process, dopants such as boron, aluminum, antimony, phosphorous, or arsenic may be ion-implanted into the die substrate 2602 to form the S/D regions 2620. An annealing process that activates the dopants and causes them to diffuse farther into the die substrate 2602 may follow the ion-implantation process. In the latter process, the die substrate 2602 may first be etched to form recesses at the locations of the S/D regions 2620. An epitaxial deposition process may then be carried out to fill the recesses with material that is used to fabricate the S/D regions 2620. In some implementations, the S/D regions 2620 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 2620 may be formed using one or more alternate semiconductor materials such as germanium or a group III-V material or alloy. In further embodiments, one or more layers of metal and/or metal alloys may be used to form the S/D regions 2620.

Electrical signals, such as power and/or input/output (I/O) signals, may be routed to and/or from the devices (e.g., transistors 2640) of the device layer 2604 through one or more interconnect layers disposed on the device layer 2604 (illustrated in FIG. 26 as interconnect layers 2606-2610). For example, electrically conductive features of the device layer 2604 (e.g., the gate 2622 and the S/D contacts 2624) may be electrically coupled with the interconnect structures 2628 of the interconnect layers 2606-2610. The one or more interconnect layers 2606-2610 may form a metallization stack (also referred to as an “ILD stack”) 2619 of the integrated circuit device 2600.

The interconnect structures 2628 may be arranged within the interconnect layers 2606-2610 to route electrical signals according to a wide variety of designs; in particular, the arrangement is not limited to the particular configuration of interconnect structures 2628 depicted in FIG. 26. Although a particular number of interconnect layers 2606-2610 is depicted in FIG. 26, embodiments of the present disclosure include integrated circuit devices having more or fewer interconnect layers than depicted.

In some embodiments, the interconnect structures 2628 may include lines 2628a and/or vias 2628b filled with an electrically conductive material such as a metal. The lines 2628a may be arranged to route electrical signals in a direction of a plane that is substantially parallel with a surface of the die substrate 2602 upon which the device layer 2604 is formed. For example, the lines 2628a may route electrical signals in a direction in and out of the page and/or in a direction across the page. The vias 2628b may be arranged to route electrical signals in a direction of a plane that is substantially perpendicular to the surface of the die substrate 2602 upon which the device layer 2604 is formed. In some embodiments, the vias 2628b may electrically couple lines 2628a of different interconnect layers 2606-2610 together.

The interconnect layers 2606-2610 may include a dielectric material 2626 disposed between the interconnect structures 2628, as shown in FIG. 26. In some embodiments, dielectric material 2626 disposed between the interconnect structures 2628 in different ones of the interconnect layers 2606-2610 may have different compositions; in other embodiments, the composition of the dielectric material 2626 between different interconnect layers 2606-2610 may be the same. The device layer 2604 may include a dielectric material 2626 disposed between the transistors 2640 and a bottom layer of the metallization stack as well. The dielectric material 2626 included in the device layer 2604 may have a different composition than the dielectric material 2626 included in the interconnect layers 2606-2610; in other embodiments, the composition of the dielectric material 2626 in the device layer 2604 may be the same as a dielectric material 2626 included in any one of the interconnect layers 2606-2610.

A first interconnect layer 2606 (referred to as Metal 1 or “M1”) may be formed directly on the device layer 2604. In some embodiments, the first interconnect layer 2606 may include lines 2628a and/or vias 2628b, as shown. The lines 2628a of the first interconnect layer 2606 may be coupled with contacts (e.g., the S/D contacts 2624) of the device layer 2604. The vias 2628b of the first interconnect layer 2606 may be coupled with the lines 2628a of a second interconnect layer 2608.

The second interconnect layer 2608 (referred to as Metal 2 or “M2”) may be formed directly on the first interconnect layer 2606. In some embodiments, the second interconnect layer 2608 may include via 2628b to couple the lines 2628 of the second interconnect layer 2608 with the lines 2628a of a third interconnect layer 2610. Although the lines 2628a and the vias 2628b are structurally delineated with a line within individual interconnect layers for the sake of clarity, the lines 2628a and the vias 2628b may be structurally and/or materially contiguous (e.g., simultaneously filled during a dual-damascene process) in some embodiments.

The third interconnect layer 2610 (referred to as Metal 3 or “M3”) (and additional interconnect layers, as desired) may be formed in succession on the second interconnect layer 2608 according to similar techniques and configurations described in connection with the second interconnect layer 2608 or the first interconnect layer 2606. In some embodiments, the interconnect layers that are “higher up” in the metallization stack 2619 in the integrated circuit device 2600 (i.e., farther away from the device layer 2604) may be thicker that the interconnect layers that are lower in the metallization stack 2619, with lines 2628a and vias 2628b in the higher interconnect layers being thicker than those in the lower interconnect layers.

The integrated circuit device 2600 may include a solder resist material 2634 (e.g., polyimide or similar material) and one or more conductive contacts 2636 formed on the interconnect layers 2606-2610. In FIG. 26, the conductive contacts 2636 are illustrated as taking the form of bond pads. The conductive contacts 2636 may be electrically coupled with the interconnect structures 2628 and configured to route the electrical signals of the transistor(s) 2640 to external devices. For example, solder bonds may be formed on the one or more conductive contacts 2636 to mechanically and/or electrically couple an integrated circuit die including the integrated circuit device 2600 with another component (e.g., a printed circuit board). The integrated circuit device 2600 may include additional or alternate structures to route the electrical signals from the interconnect layers 2606-2610; for example, the conductive contacts 2636 may include other analogous features (e.g., posts) that route the electrical signals to external components. The conductive contacts 2636 may serve as the conductive contacts 208, as appropriate.

In some embodiments in which the integrated circuit device 2600 is a double-sided die, the integrated circuit device 2600 may include another metallization stack (not shown) on the opposite side of the device layer(s) 2604. This metallization stack may include multiple interconnect layers as discussed above with reference to the interconnect layers 2606-2610, to provide conductive pathways (e.g., including conductive lines and vias) between the device layer(s) 2604 and additional conductive contacts (not shown) on the opposite side of the integrated circuit device 2600 from the conductive contacts 2636. These additional conductive contacts may serve as the conductive contacts 208, as appropriate.

In other embodiments in which the integrated circuit device 2600 is a double-sided die, the integrated circuit device 2600 may include one or more through silicon vias (TSVs) through the die substrate 2602; these TSVs may make contact with the device layer(s) 2604, and may provide conductive pathways between the device layer(s) 2604 and additional conductive contacts (not shown) on the opposite side of the integrated circuit device 2600 from the conductive contacts 2636. These additional conductive contacts may serve as the conductive contacts 208, as appropriate. In some embodiments, TSVs extending through the substrate can be used for routing power and ground signals from conductive contacts on the opposite side of the integrated circuit device 2600 from the conductive contacts 2636 to the transistors 2640 and any other components integrated into the die 2600, and the metallization stack 2619 can be used to route I/O signals from the conductive contacts 2636 to transistors 2640 and any other components integrated into the die 2600.

Multiple integrated circuit devices 2600 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

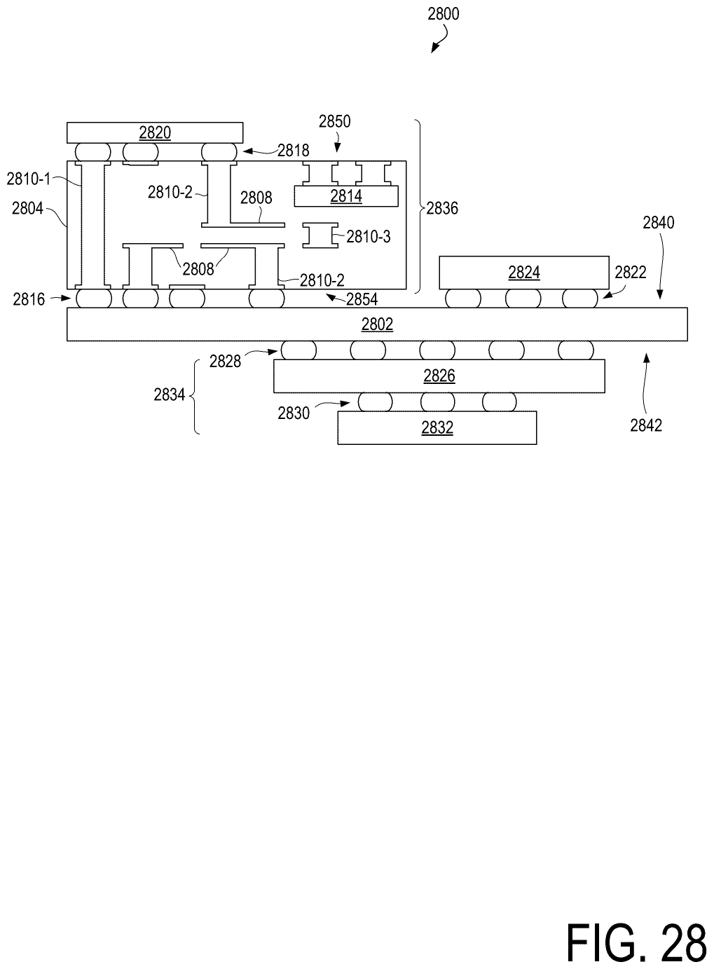

FIG. 28 is a cross-sectional side view of an integrated circuit device assembly 2800 that may include any of the integrated circuit components 100 disclosed herein. In some embodiments, the integrated circuit device assembly 2800 may be an integrated circuit component 100. The integrated circuit device assembly 2800 includes a number of components disposed on a circuit board 2802 (which may be a motherboard, system board, mainboard, etc.). The integrated circuit device assembly 2800 includes components disposed on a first face 2840 of the circuit board 2802 and an opposing second face 2842 of the circuit board 2802; generally, components may be disposed on one or both faces 2840 and 2842. Any of the integrated circuit components discussed below with reference to the integrated circuit device assembly 2800 may take the form of any suitable ones of the embodiments of the integrated circuit components 100 disclosed herein.

In some embodiments, the circuit board 2802 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 2802. In other embodiments, the circuit board 2802 may be a non-PCB substrate. In some embodiments the circuit board 2802 may be, for example, the circuit board 102. The integrated circuit device assembly 2800 illustrated in FIG. 28 includes a package-on-interposer structure 2836 coupled to the first face 2840 of the circuit board 2802 by coupling components 2816. The coupling components 2816 may electrically and mechanically couple the package-on-interposer structure 2836 to the circuit board 2802, and may include solder balls (as shown in FIG. 28), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 2816 may serve as the coupling components illustrated or described for any of the substrate assembly or substrate assembly components described herein, as appropriate.

The package-on-interposer structure 2836 may include an integrated circuit component 2820 coupled to an interposer 2804 by coupling components 2818. The coupling components 2818 may take any suitable form for the application, such as the forms discussed above with reference to the coupling components 2816. Although a single integrated circuit component 2820 is shown in FIG. 28, multiple integrated circuit components may be coupled to the interposer 2804; indeed, additional interposers may be coupled to the interposer 2804. The interposer 2804 may provide an intervening substrate used to bridge the circuit board 2802 and the integrated circuit component 2820.

The integrated circuit component 2820 may be a packaged or unpacked integrated circuit product that includes one or more integrated circuit dies (e.g., the die 2502 of FIG. 25, the integrated circuit device 2600 of FIG. 26) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 2820, a single monolithic integrated circuit die comprises solder bumps attached to contacts on the die. The solder bumps allow the die to be directly attached to the interposer 2804. The integrated circuit component 2820 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 2820 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 2820 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 2820 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 2804 may spread connections to a wider pitch or reroute a connection to a different connection. For example, the interposer 2804 may couple the integrated circuit component 2820 to a set of ball grid array (BGA) conductive contacts of the coupling components 2816 for coupling to the circuit board 2802. In the embodiment illustrated in FIG. 28, the integrated circuit component 2820 and the circuit board 2802 are attached to opposing sides of the interposer 2804; in other embodiments, the integrated circuit component 2820 and the circuit board 2802 may be attached to a same side of the interposer 2804. In some embodiments, three or more components may be interconnected by way of the interposer 2804.

In some embodiments, the interposer 2804 may be formed as a PCB, including multiple metal layers separated from one another by layers of dielectric material and interconnected by electrically conductive vias. In some embodiments, the interposer 2804 may be formed of an epoxy resin, a fiberglass-reinforced epoxy resin, an epoxy resin with inorganic fillers, a ceramic material, or a polymer material such as polyimide. In some embodiments, the interposer 2804 may be formed of alternate rigid or flexible materials that may include the same materials described above for use in a semiconductor substrate, such as silicon, germanium, and other group III-V and group IV materials. The interposer 2804 may include metal interconnects 2808 and vias 2810, including but not limited to through hole vias 2810-1 (that extend from a first face 2850 of the interposer 2804 to a second face 2854 of the interposer 2804), blind vias 2810-2 (that extend from the first or second faces 2850 or 2854 of the interposer 2804 to an internal metal layer), and buried vias 2810-3 (that connect internal metal layers).

In some embodiments, the interposer 2804 can comprise a silicon interposer. Through silicon vias (TSV) extending through the silicon interposer can connect connections on a first face of a silicon interposer to an opposing second face of the silicon interposer. In some embodiments, an interposer 2804 comprising a silicon interposer can further comprise one or more routing layers to route connections on a first face of the interposer 2804 to an opposing second face of the interposer 2804.

The interposer 2804 may further include embedded devices 2814, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 2804. The package-on-interposer structure 2836 may take the form of any of the package-on-interposer structures known in the art.

The integrated circuit device assembly 2800 may include an integrated circuit component 2824 coupled to the first face 2840 of the circuit board 2802 by coupling components 2822. The coupling components 2822 may take the form of any of the embodiments discussed above with reference to the coupling components 2816, and the integrated circuit component 2824 may take the form of any of the embodiments discussed above with reference to the integrated circuit component 2820.

The integrated circuit device assembly 2800 illustrated in FIG. 28 includes a package-on-package structure 2834 coupled to the second face 2842 of the circuit board 2802 by coupling components 2828. The package-on-package structure 2834 may include an integrated circuit component 2826 and an integrated circuit component 2832 coupled together by coupling components 2830 such that the integrated circuit component 2826 is disposed between the circuit board 2802 and the integrated circuit component 2832. The coupling components 2828 and 2830 may take the form of any of the embodiments of the coupling components 2816 discussed above, and the integrated circuit components 2826 and 2832 may take the form of any of the embodiments of the integrated circuit component 2820 discussed above. The package-on-package structure 2834 may be configured in accordance with any of the package-on-package structures known in the art.

FIG. 29 is a block diagram of an example electrical device 2900 that may include one or more of the integrated circuit components 100 disclosed herein. For example, any suitable ones of the components of the electrical device 2900 may include one or more of the integrated circuit device assemblies 2800, integrated circuit components 2820, integrated circuit devices 2600, or integrated circuit dies 2502 disclosed herein, and may be arranged in any of the integrated circuit components 100 disclosed herein. A number of components are illustrated in FIG. 29 as included in the electrical device 2900, but any one or more of these components may be omitted or duplicated, as suitable for the application. In some embodiments, some or all of the components included in the electrical device 2900 may be attached to one or more motherboards mainboards, or system boards. In some embodiments, one or more of these components are fabricated onto a single system-on-a-chip (SoC) die.

Additionally, in various embodiments, the electrical device 2900 may not include one or more of the components illustrated in FIG. 29, but the electrical device 2900 may include interface circuitry for coupling to the one or more components. For example, the electrical device 2900 may not include a display device 2906, but may include display device interface circuitry (e.g., a connector and driver circuitry) to which a display device 2906 may be coupled. In another set of examples, the electrical device 2900 may not include an audio input device 2924 or an audio output device 2908, but may include audio input or output device interface circuitry (e.g., connectors and supporting circuitry) to which an audio input device 2924 or audio output device 2908 may be coupled.

The electrical device 2900 may include one or more processor units 2902 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 2902 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 2900 may include a memory 2904, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 2904 may include memory that is located on the same integrated circuit die as the processor unit 2902. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 2900 can comprise one or more processor units 2902 that are heterogeneous or asymmetric to another processor unit 2902 in the electrical device 2900. There can be a variety of differences between the processing units 2902 in a system in terms of a spectrum of metrics of merit including architectural, microarchitectural, thermal, power consumption characteristics, and the like. These differences can effectively manifest themselves as asymmetry and heterogeneity among the processor units 2902 in the electrical device 2900.

In some embodiments, the electrical device 2900 may include a communication component 2912 (e.g., one or more communication components). For example, the communication component 2912 can manage wireless communications for the transfer of data to and from the electrical device 2900. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 2912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 2912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 2912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 2912 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 2912 may operate in accordance with other wireless protocols in other embodiments. The electrical device 2900 may include an antenna 2922 to facilitate wireless communications and/or to receive other wireless communications (such as AM or FM radio transmissions).

In some embodiments, the communication component 2912 may manage wired communications, such as electrical, optical, or any other suitable communication protocols (e.g., IEEE 802.3 Ethernet standards). As noted above, the communication component 2912 may include multiple communication components. For instance, a first communication component 2912 may be dedicated to shorter-range wireless communications such as Wi-Fi or Bluetooth, and a second communication component 2912 may be dedicated to longer-range wireless communications such as global positioning system (GPS), EDGE, GPRS, CDMA, WiMAX, LTE, EV-DO, or others. In some embodiments, a first communication component 2912 may be dedicated to wireless communications, and a second communication component 2912 may be dedicated to wired communications.

The electrical device 2900 may include battery/power circuitry 2914. The battery/power circuitry 2914 may include one or more energy storage devices (e.g., batteries or capacitors) and/or circuitry for coupling components of the electrical device 2900 to an energy source separate from the electrical device 2900 (e.g., AC line power).

The electrical device 2900 may include a display device 2906 (or corresponding interface circuitry, as discussed above). The display device 2906 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 2900 may include an audio output device 2908 (or corresponding interface circuitry, as discussed above). The audio output device 2908 may include any embedded or wired or wirelessly connected external device that generates an audible indicator, such as speakers, headsets, or earbuds.

The electrical device 2900 may include an audio input device 2924 (or corresponding interface circuitry, as discussed above). The audio input device 2924 may include any embedded or wired or wirelessly connected device that generates a signal representative of a sound, such as microphones, microphone arrays, or digital instruments (e.g., instruments having a musical instrument digital interface (MIDI) output). The electrical device 2900 may include a Global Navigation Satellite System (GNSS) device 2918 (or corresponding interface circuitry, as discussed above), such as a Global Positioning System (GPS) device. The GNSS device 2918 may be in communication with a satellite-based system and may determine a geolocation of the electrical device 2900 based on information received from one or more GNSS satellites, as known in the art.

The electrical device 2900 may include an other output device 2910 (or corresponding interface circuitry, as discussed above). Examples of the other output device 2910 may include an audio codec, a video codec, a printer, a wired or wireless transmitter for providing information to other devices, or an additional storage device.

The electrical device 2900 may include an other input device 2920 (or corresponding interface circuitry, as discussed above). Examples of the other input device 2920 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 2900 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 2900 may be any other electronic device that processes data. In some embodiments, the electrical device 2900 may comprise multiple discrete physical components. Given the range of devices that the electrical device 2900 can be manifested as in various embodiments, in some embodiments, the electrical device 2900 can be referred to as a computing device or a computing system.

### EXAMPLES

Illustrative examples of the technologies disclosed herein are provided below. An embodiment of the technologies may include any one or more, and any combination of, the examples described below.

Example 1 includes an integrated circuit component comprising a photonic integrated circuit (PIC) die comprising a first plurality of waveguides defined therein; and an optical interposer comprising a body; a second plurality of waveguides defined in the optical interposer; a plurality of actuator beams, wherein, for individual actuator beams of the plurality of actuator beams, a corresponding waveguide of the second plurality of waveguides extends to an end of the actuator beam; and one or more traces disposed at least partially on a surface of individual actuator beams of the plurality of actuator beams, wherein the plurality of actuator beams extend from the body of the optical interposer towards the PIC die.

Example 2 includes the subject matter of Example 1, and wherein, when current is passed through the one or more traces, the ends of the plurality of actuator beams are deflected by at least one micrometer.

Example 3 includes the subject matter of any of Examples 1 and 2, and further including control circuitry to control an amount of current through the one or more traces to align the second plurality of waveguides to the first plurality of waveguides.

Example 4 includes the subject matter of any of Examples 1-3, and wherein the one or more traces comprises a first trace disposed at least partially on a first actuator beam of the plurality of actuator beams; and a second trace disposed at least partially on a second actuator beam of the plurality of actuator beams.

Example 5 includes the subject matter of any of Examples 1-4, and wherein, when current passes through the first trace, the plurality of actuator beams twist in a first direction, wherein, when current passes through the second trace, the plurality of actuator beams twist in a second direction opposite the first direction.

Example 6 includes the subject matter of any of Examples 1-5, and further including an integrated heat spreader, wherein the optical interposer is secured to the integrated heat spreader by an adhesive.

Example 7 includes the subject matter of any of Examples 1-6, and wherein the PIC die comprises a V-groove array, wherein, when current passes through the one or more traces, the plurality of actuator beams are pressed into the V-groove array.

Example 8 includes the subject matter of any of Examples 1-7, and further including a substrate and an electronic integrated circuit (EIC) die, wherein the EIC die is mounted on the substrate, wherein an underside of the EIC die is facing towards the substrate, wherein the PIC die is disposed in a recess of the substrate, wherein the PIC die is mounted on the underside of the EIC die.

Example 9 includes the subject matter of any of Examples 1-8, and wherein the plurality of actuator beams can actuate due to thermal expansion of the one or more traces.

Example 10 includes the subject matter of any of Examples 1-9, and wherein the plurality of actuator beams can actuate due electrostatic attraction, electromagnetic force, electrostriction, or piezoelectric force.

Example 11 includes the subject matter of any of Examples 1-10, and wherein the optical interposer further comprises a crossbar joining the plurality of actuator beams.

Example 12 includes the subject matter of any of Examples 1-11, and wherein the ends of the plurality of actuator beams are not connected to another actuator beam.

Example 13 includes the subject matter of any of Examples 1-12, and wherein the one or more traces comprises a plurality of traces, wherein individual actuator beams of the plurality of actuator beams have disposed on a corresponding surface one of the plurality of traces, further comprising control circuitry to control an amount of current through individual traces of the plurality of traces to independently control a position of individual actuator beams of the plurality of actuator beams.

Example 14 includes the subject matter of any of Examples 1-13, and further including a ribbon cable mounted on the optical interposer, the ribbon cable electrically coupled to the one or more traces.

Example 15 includes the subject matter of any of Examples 1-14, and further including a first trace and a second trace, wherein the first trace is disposed at least partially on a top surface of one of the plurality of actuator beams, wherein the second trace is disposed at least partially on a side surface of one of the plurality of actuator beams.

Example 16 includes the subject matter of any of Examples 1-15, and further including control circuitry to control an amount of current through the first trace move the plurality of actuator beams in a first direction; and control an amount of current through the second trace move the plurality of actuator beams in a second direction orthogonal to the first.

Example 17 includes the subject matter of any of Examples 1-16, and wherein the integrated circuit component is a processor.

Example 18 includes an integrated circuit component comprising a photonic integrated circuit (PIC) die comprising a first plurality of waveguides defined therein; an optical interposer comprising a body; a second plurality of waveguides defined in the optical interposer; and a plurality of actuator beams, wherein, for individual actuator beams of the plurality of actuator beams, a corresponding waveguide of the second plurality of waveguides extends to an end of the actuator beam, wherein the plurality of actuator beams extend from the body of the optical interposer towards the PIC die, and an integrated heat spreader, wherein the optical interposer is secured to the integrated heat spreader by an adhesive.

Example 19 includes the subject matter of Example 18, and wherein the optical interposer further comprises one or more traces disposed at least partially on a surface of individual actuator beams of the plurality of actuator beams.

Example 20 includes the subject matter of any of Examples 18 and 19, and wherein, when current is passed through the one or more traces, the ends of the plurality of actuator beams are deflected by at least one micrometer.

Example 21 includes the subject matter of any of Examples 18-20, and further including control circuitry to control an amount of current through the one or more traces to align the second plurality of waveguides to the first plurality of waveguides.

Example 22 includes the subject matter of any of Examples 18-21, and wherein the one or more traces comprises a first trace disposed at least partially on a first actuator beam of the plurality of actuator beams; and a second trace disposed at least partially on a second actuator beam of the plurality of actuator beams.

Example 23 includes the subject matter of any of Examples 18-22, and wherein, when current passes through the first trace, the plurality of actuator beams twist in a first direction, wherein, when current passes through the second trace, the plurality of actuator beams twist in a second direction opposite the first direction.

Example 24 includes the subject matter of any of Examples 18-23, and further including a ribbon cable mounted on the optical interposer, the ribbon cable electrically coupled to the one or more traces.

Example 25 includes the subject matter of any of Examples 18-24, and wherein the PIC die comprises a V-groove array, wherein, when current passes through the one or more traces, the plurality of actuator beams are pressed into the V-groove array.

Example 26 includes the subject matter of any of Examples 18-25, and wherein the plurality of actuator beams can actuate due thermal expansion, electrostatic attraction, electromagnetic force, electrostriction, or piezoelectric force.

Example 27 includes the subject matter of any of Examples 18-26, and wherein the optical interposer further comprises a crossbar joining the plurality of actuator beams.

Example 28 includes the subject matter of any of Examples 18-27, and wherein the ends of the plurality of actuator beams are not connected to another actuator beam.

Example 29 includes the subject matter of any of Examples 18-28, and wherein the optical interposer comprises a plurality of traces, wherein individual actuator beams of the plurality of actuator beams have disposed on a corresponding surface one of the plurality of traces, further comprising control circuitry to control an amount of current through individual traces of the plurality of traces to independently control a position of individual actuator beams of the plurality of actuator beams.

Example 30 includes the subject matter of any of Examples 18-29, and further including a first trace and a second trace, wherein the first trace is disposed at least partially on a top surface of one of the plurality of actuator beams, wherein the second trace is disposed at least partially on a side surface of one of the plurality of actuator beams.

Example 31 includes the subject matter of any of Examples 18-30, and further including control circuitry to control an amount of current through the first trace move the plurality of actuator beams in a first direction; and control an amount of current through the second trace move the plurality of actuator beams in a second direction orthogonal to the first.

Example 32 includes the subject matter of any of Examples 18-31, and wherein the integrated circuit component is a processor.

Example 33 includes an integrated circuit component comprising a photonic integrated circuit (PIC) die comprising a first plurality of waveguides defined therein; and an optical interposer comprising a body; a second plurality of waveguides defined in the optical interposer; a plurality of actuator beams, wherein, for individual actuator beams of the plurality of actuator beams, a corresponding waveguide of the second plurality of waveguides extends to an end of the actuator beam; and actuating means for actuating the plurality of actuator beams, wherein the plurality of actuator beams extend from the body of the optical interposer towards the PIC die.

Example 34 includes the subject matter of Example 33, and wherein, when current is passed through the actuating means, the ends of the plurality of actuator beams are deflected by at least one micrometer.

Example 35 includes the subject matter of any of Examples 33 and 34, and further including control circuitry to control an amount of current through the actuating means to align the second plurality of waveguides to the first plurality of waveguides.

Example 36 includes the subject matter of any of Examples 33-35, and wherein the actuating means comprises a first trace disposed at least partially on a first actuator beam of the plurality of actuator beams; and a second trace disposed at least partially on a second actuator beam of the plurality of actuator beams.

Example 37 includes the subject matter of any of Examples 33-36, and wherein, when current passes through the first trace, the plurality of actuator beams twist in a first direction, wherein, when current passes through the second trace, the plurality of actuator beams twist in a second direction opposite the first direction.

Example 38 includes the subject matter of any of Examples 33-37, and further including an integrated heat spreader, wherein the optical interposer is secured to the integrated heat spreader by an adhesive.

Example 39 includes the subject matter of any of Examples 33-38, and wherein the PIC die comprises a V-groove array, wherein, when current passes through the actuating means, the plurality of actuator beams are pressed into the V-groove array.

Example 40 includes the subject matter of any of Examples 33-39, and further including a substrate and an electronic integrated circuit (EIC) die, wherein the EIC die is mounted on the substrate, wherein an underside of the EIC die is facing towards the substrate, wherein the PIC die is disposed in a recess of the substrate, wherein the PIC die is mounted on the underside of the EIC die.

Example 41 includes the subject matter of any of Examples 33-40, and wherein the plurality of actuator beams can actuate due to thermal expansion of the actuating means.

Example 42 includes the subject matter of any of Examples 33-41, and wherein the plurality of actuator beams can actuate due electrostatic attraction, electromagnetic force, electrostriction, or piezoelectric force.

Example 43 includes the subject matter of any of Examples 33-42, and wherein the optical interposer further comprises a crossbar joining the plurality of actuator beams.

Example 44 includes the subject matter of any of Examples 33-43, and wherein the ends of the plurality of actuator beams are not connected to another actuator beam.

Example 45 includes the subject matter of any of Examples 33-44, and wherein the actuating means comprises a plurality of traces, wherein individual actuator beams of the plurality of actuator beams have disposed on a corresponding surface one of the plurality of traces, further comprising control circuitry to control an amount of current through individual traces of the plurality of traces to independently control a position of individual actuator beams of the plurality of actuator beams.

Example 46 includes the subject matter of any of Examples 33-45, and further including a ribbon cable mounted on the optical interposer, the ribbon cable electrically coupled to the actuating means.

Example 47 includes the subject matter of any of Examples 33-46, and further including a first trace and a second trace, wherein the first trace is disposed at least partially on a top surface of one of the plurality of actuator beams, wherein the second trace is disposed at least partially on a side surface of one of the plurality of actuator beams.

Example 48 includes the subject matter of any of Examples 33-47, and further including control circuitry to control an amount of current through the first trace move the plurality of actuator beams in a first direction; and control an amount of current through the second trace move the plurality of actuator beams in a second direction orthogonal to the first.

Example 49 includes the subject matter of any of Examples 33-48, and wherein the integrated circuit component is a processor.

1. An integrated circuit component comprising:
a photonic integrated circuit (PIC) die comprising a first plurality of waveguides defined therein; and
an optical interposer comprising:
a body;
a second plurality of waveguides defined in the optical interposer;
a plurality of actuator beams, wherein, for individual actuator beams of the plurality of actuator beams, a corresponding waveguide of the second plurality of waveguides extends to an end of the actuator beam; and
one or more traces disposed at least partially on a surface of individual actuator beams of the plurality of actuator beams,
wherein the plurality of actuator beams extend from the body of the optical interposer towards the PIC die.

2. The integrated circuit component of claim 1, wherein, when current is passed through the one or more traces, the ends of the plurality of actuator beams are deflected by at least one micrometer.

3. The integrated circuit component of claim 1, further comprising control circuitry to control an amount of current through the one or more traces to align the second plurality of waveguides to the first plurality of waveguides.

4. The integrated circuit component of claim 1, wherein the one or more traces comprises:
a first trace disposed at least partially on a first actuator beam of the plurality of actuator beams; and
a second trace disposed at least partially on a second actuator beam of the plurality of actuator beams.

5. The integrated circuit component of claim 4, wherein, when current passes through the first trace, the plurality of actuator beams twist in a first direction, wherein, when current passes through the second trace, the plurality of actuator beams twist in a second direction opposite the first direction.

6. The integrated circuit component of claim 1, further comprising an integrated heat spreader, wherein the optical interposer is secured to the integrated heat spreader by an adhesive.

7. The integrated circuit component of claim 1, wherein the PIC die comprises a V-groove array, wherein, when current passes through the one or more traces, the plurality of actuator beams are pressed into the V-groove array.

8. The integrated circuit component of claim 1, further comprising a substrate and an electronic integrated circuit (EIC) die, wherein the EIC die is mounted on the substrate, wherein an underside of the EIC die is facing towards the substrate, wherein the PIC die is disposed in a recess of the substrate, wherein the PIC die is mounted on the underside of the EIC die.

9. The integrated circuit component of claim 1, wherein the plurality of actuator beams can actuate due to thermal expansion of the one or more traces.

10. The integrated circuit component of claim 1, wherein the plurality of actuator beams can actuate due electrostatic attraction, electromagnetic force, electrostriction, or piezoelectric force.

11. The integrated circuit component of claim 1, further comprising a ribbon cable mounted on the optical interposer, the ribbon cable electrically coupled to the one or more traces.

12. The integrated circuit component of claim 1, comprising a first trace and a second trace, wherein the first trace is disposed at least partially on a top surface of one of the plurality of actuator beams, wherein the second trace is disposed at least partially on a side surface of one of the plurality of actuator beams.

13. The integrated circuit component of claim 12, further comprising control circuitry to:
control an amount of current through the first trace move the plurality of actuator beams in a first direction; and
control an amount of current through the second trace move the plurality of actuator beams in a second direction orthogonal to the first.

14. The integrated circuit component of claim 1, wherein the integrated circuit component is a processor.

15. An integrated circuit component comprising:
a photonic integrated circuit (PIC) die comprising a first plurality of waveguides defined therein;
an optical interposer comprising:
a body;
a second plurality of waveguides defined in the optical interposer; and
a plurality of actuator beams, wherein, for individual actuator beams of the plurality of actuator beams, a corresponding waveguide of the second plurality of waveguides extends to an end of the actuator beam,
wherein the plurality of actuator beams extend from the body of the optical interposer towards the PIC die, and
an integrated heat spreader, wherein the optical interposer is secured to the integrated heat spreader by an adhesive.

16. The integrated circuit component of claim 15, wherein the optical interposer further comprises a crossbar joining the plurality of actuator beams.

17. The integrated circuit component of claim 15, wherein the ends of the plurality of actuator beams are not connected to another actuator beam.

18. The integrated circuit component of claim 17, wherein the optical interposer comprises a plurality of traces, wherein individual actuator beams of the plurality of actuator beams have disposed on a corresponding surface one of the plurality of traces, further comprising control circuitry to control an amount of current through individual traces of the plurality of traces to independently control a position of individual actuator beams of the plurality of actuator beams.

19. An integrated circuit component comprising:
a photonic integrated circuit (PIC) die comprising a first plurality of waveguides defined therein; and
an optical interposer comprising:
a body;
a second plurality of waveguides defined in the optical interposer;
a plurality of actuator beams, wherein, for individual actuator beams of the plurality of actuator beams, a corresponding waveguide of the second plurality of waveguides extends to an end of the actuator beam; and
actuating means for actuating the plurality of actuator beams,
wherein the plurality of actuator beams extend from the body of the optical interposer towards the PIC die.

20. The integrated circuit component of claim 19, wherein, when current is passed through the actuating means, the ends of the plurality of actuator beams are deflected by at least one micrometer.
